(19) United States
(12) Patent Application Publication
(10) Pub. No.: US 2025/0292460 A1
(43) Pub. Date: Sep. 18, 2025

(54) LANE GRAPH GENERATION USING NEURAL NETWORKS

(71) Applicant: NVIDIA Corporation, Santa Clara, CA (US)

(72) Inventors: Amala Sanjay DESHMUKH, Mountain View, CA (US); Farzan Nowruzi, Burnaby, CA (US); Vadim Cugunovs, Bellevue, WA (US); Michael Grabner, Redwood, WA (US)

(21) Appl. No.: 18/603,078

(22) Filed: Mar. 12, 2024

(51) Int. Cl. G06T 11/20; G06T 3/4038; G06T 7/11; G06T 7/13; G06T 9/00

(52) U.S. Cl. CPC G06T 11/206; G06T 3/4038; G06T 7/11; G06T 7/13; G06T 9/00; G06T 2207/20084; G06T 2207/20221; G06T 2207/30241; G06T 2207/30256

(57) ABSTRACT

In various examples, various types of sensor data from multiple ego-machines are used to infer lanes and/or generate lane graphs for use in autonomous systems and applications. In some embodiments, one or more DNNs may be used to infer lane data indicating a representation of a lane shape using sensor data from various vehicles to represent a 3D environment. The inferred lane data may include cross-section indicators that indicate cross-sections of a lane and/or connection indicators that indicate a lane channel connecting two locations (e.g., two lane portions). The inferred lane data may be used to generate a lane graph that represents lanes on a road and, in some cases, lane dividers (e.g., polyline represented as a solid line, a dashed line, a double line, etc.). A lane graph may be used, for example, to model the environment around a vehicle, facilitate localization, provide guidance for autonomous driving, etc.

### CROSS-REFERENCE TO RELATED APPLICATIONS

This application is related to U.S. Application No. TBD, entitled “Lane Inference and Lane Graph Generation for Autonomous Systems and Applications,” filed on Mar. 12, 2024, which is incorporated by reference herein.

### BACKGROUND

Designing a system to safely drive a vehicle autonomously without supervision or semi-autonomously with limited supervision is tremendously difficult. For example, some designs seek to have an autonomous vehicle or other ego-machine be capable of performing as a functional equivalent of an attentive driver—who draws upon a perception and action system that has an incredible ability to identify and react to moving and static obstacles in a complex environment—to avoid other objects or structures along the path of the vehicle. In designing such a system, lane graphs are generally used to facilitate localization (e.g., positioning an eco-machine in a map), path planning (e.g., determining candidate routes for an ego-machine), and/or decision making (e.g. determining an optimal route based on the candidate paths, vehicle state, and environment). For example, autonomous driving perception systems may use localization to locate the ego-machine's precise location in a map, providing an awareness of the road and/or lane being traveled, including upcoming turns, forks, and merging of lanes. Further, localization facilitates making decisions based on environment features that are beyond the ego-machine's field of view and/or are occluded by other objects or conditions in the environment (e.g., avoiding a last second lane merge when approaching the end of a lane represented in a map). In another example, localization facilitates contextualizing observed behaviors of other actors in the map and making corresponding decisions (e.g., determining that an oncoming vehicle is in a left-turn only lane and, therefore, that the oncoming vehicle will turn left, making it safe for an autonomous vehicle to make an unprotected left turn). Accordingly, generating accurate lane graphs is valuable for effectively facilitating localization, path planning, and/or decision making.

To identify lanes, one conventional approach uses existing vehicle trajectories. Using trajectories to identify lanes, however, often provides inconclusive or error-prone information. For example, using a vehicle trajectory, it is difficult to detect whether the vehicle is moving from one lane to another or if lanes are merging. As another example, in some cases, trajectories have not been generated for some areas or regions.

Another conventional approach to identify lanes includes performing path perception as a vehicle is on the road. Generally, this approach uses camera images to detect a path being traveled as well as the left and/or right adjacent paths using images, thereby generating lane estimates. Such lane estimates, however, may also be inconclusive or error-prone. For example, the lane estimate is dependent on the perception perspective of the particular vehicle. In this regard, different vehicles may perceive dividers in inconsistent locations. As another example, images, from which lanes are estimated, may not capture dividers, thereby increasing inaccuracy in lane estimates. For instance, intersections oftentimes do not include dividers. Further, in some cases, dividers may be too far in distance to be appropriately captured in an image for use in generating lane estimates. In this way, lane estimates may be absent or inaccurate for various areas.

As such, conventional lane detection methods have limited functionality, accuracy, and/or precision, such as when using limited types of sensor data (e.g., images only), when using sensor data associated with a single ego-machine, and/or when performing lane detection analysis in an online manner, limiting the ability to effectively navigate an autonomous vehicle though an environment.

### SUMMARY

Embodiments of the present disclosure relate to lane inference and lane graph generation for autonomous systems and applications. Systems and methods are disclosed that that use various types of sensor data from multiple ego-machines to infer lanes and/or generate lane graphs for use in localization, navigation, and/or other uses by autonomous vehicles, semi-autonomous vehicles, robots, and/or other object or machine types.

In contrast to conventional systems, such as those described above, in some embodiments, a deep neural network (DNN) (e.g., in the form of a transformer) may be used for lane inference and lane graph generation in autonomous or semi-autonomous systems and applications. For example, systems and methods are disclosed that use learning-based inferences of lane data to identify or detect instances of lanes for use in localization, navigation, and/or other uses by autonomous vehicles, semi-autonomous vehicles, robots, and/or other object or machine types.

At a high level, one or more DNNs may be used to infer lane data indicating a representation of a lane shape using sensor data from various vehicles to represent a three-dimensional (3D) environment. In some embodiments, the inferred lane data includes cross-section indicators that indicate cross-sections (e.g., a reference point with a left position and a right position) and/or connection indicators that indicate a lane channel connecting two locations (e.g., two lane portions). The inferred lane data, such as cross-sections and/or connection indicators, may be used to generate a lane graph that represents lanes on a road and, in some cases, lane dividers (e.g., polyline represented as a solid line, a dashed line, a double line, etc.). A lane graph may be used, for example, to model the environment around a vehicle, facilitate localization, provide guidance for autonomous driving, etc.

In operation, sensor data generated by a fleet of ego-machines may be obtained. The sensor data may include polyline features (e.g., dividers, trajectories, and lane estimates) and point features (e.g., generated via RADAR and/or LiDAR). The sensor data may be processed into a format that is accepted by one or more deep neural networks (DNN) used to infer lane data indicating a lane. As one example, a DNN takes, as input, cell representations that represent cells or portions of a region. In this regard, cell representations that each represent a collection of points (e.g., representative of a polyline indicating a lane estimate, a divider, a trajectory) within a corresponding cell of a region of an environment scene are used to generate lane data indicating a lane(s). As such, the collected sensor data may be used to generate cell representations that represent the collected sensor data associated with cells.

In some embodiments, in accordance with generating cell representations for cells associated with a region of an environment scene, the cell representations may be provided, as input, to one or more DNNs for processing to generate lane data. In embodiments, a DNN for use in generating lane data includes encoder and decoder components (e.g., implemented using a transformer architecture). Encoding may be performed to take the cell representations as input and generate a latent representation for the region. In one embodiment, a hierarchical encoder is used to generate the latent representation for the region. In this regard, a cell encoder (e.g., including cross-attention and multiple self-attention units) is used to extract features and generate cell latent representations, and a global encoder (e.g., including multiple self-attention units) is used to relate the cell latent representations to one another and generate a region latent representation representing the region.

Based on the latent representation for the region, one or more decoder components may infer or generate lane data. In some embodiments, inferred lane data may include cross-section indicators that indicate cross-sections (e.g., a reference point with a left position and a right position) and/or connection indicators that indicate a lane channel connecting two locations. In some implementations, a cross-section decoder may be used to infer cross-section indicators, and a connection decoder may be used to infer connection indicators. In other embodiments, a single decoder may be used to infer lane data for use in generating a lane graph. In this regard, the decoder may function to generate or output lane data that specifies a geometry for a lane (e.g., pair of Bezier curves or lane edges).

In accordance with inferring a lane(s) via the lane data, the lane data, such as cross-section indicators and/or connection indicators, may be used to generate a lane graph. A lane graph may be implemented using any suitable data structure that represents lanes on a road and, in some cases, lane dividers (e.g., polyline represented as a solid line, a dashed line, a double line, etc.). For example, at a high level, the lane data may be projected back to the environment scene (e.g., global map view) to generate a lane graph. The post-processing techniques employed to generate the lane graph from the inferred lane data may depend on the manner in which the lane data is represented by one or more decoders. As can be appreciated, a lane graph may be used, for example, to model the environment around a vehicle or other ego-machine, facilitate localization, provide guidance for autonomous driving, etc.

### BRIEF DESCRIPTION OF THE DRAWINGS

The present systems and methods for lane inference and lane graph generation for autonomous systems and applications are described in detail below with reference to the attached drawing figures, wherein:

FIG. 1 is a data flow diagram illustrating an example process for a lane graph generation system, in accordance with some embodiments of the present disclosure;

FIG. 2 is a data flow diagram illustrating an example process for inferring lanes and generating lane graphs based on one or more machine learning models in the form of one or more DNNs, in accordance with some embodiments of the present disclosure;

FIG. 3 is an illustration of a perspective view or a top-down representation of projected 3D locations of measured 3D points, in accordance with some embodiments of the present disclosure;

FIG. 4 is an illustration of a dilated cell within a region, in accordance with some embodiments of the present disclosure;

FIG. 5 is an illustration of an anchor grid with anchor points positioned within a region, in accordance with some embodiments of the present disclosure;

FIG. 6 is an illustration of an example of cross-section indicators indicating cross-sections, in accordance with some embodiments of the present disclosure;

FIG. 7 is an illustration of example lane connection between a pair of anchor points, in accordance with some embodiments of the present disclosure;

FIG. 8 is an illustration of connected lanes that may be predicted via a connection decoder, in accordance with some embodiments of the present disclosure;

FIG. 9 is a data flow diagram illustrating an example process flow for performing various post-processing operations in association with identifying lane cross-sections, in accordance with some embodiments of the present disclosure;

FIG. 10. is an illustration of an example for removing duplicate lanes, in accordance with some embodiments of the present disclosure;

FIG. 11 is an illustration of an example for smoothing lane connections, in accordance with some embodiments of the present disclosure;

FIG. 12 is an illustration of an example stub-to-stub connection, in accordance with some embodiments of the present disclosure;

FIG. 13 is an illustration of an example stub-to-lane connection, in accordance with some embodiments of the present disclosure;

FIG. 14 is an example flow diagram for performing lane inference using hierarchical encoders in a transformer model, in accordance with some embodiments of the present disclosure;

FIG. 15 provides an example method for generating input data for lane inference and/or lane graph generation, in accordance with some embodiments of the present disclosure;

FIG. 16 provides an example method for generating one or lane inferences using one or more neural networks, in accordance with some embodiments of the present disclosure;

FIG. 17 provides an example method for generating lane graphs using one or more neural networks, in accordance with some embodiments of the present disclosure;

FIG. 18 provides another example method for generating lane graphs using one or more neural networks, in accordance with some embodiments of the present disclosure;

FIG. 19A is an illustration of an example autonomous vehicle, in accordance with some embodiments of the present disclosure;

FIG. 19B is an example of camera locations and fields of view for the example autonomous vehicle of FIG. 19A, in accordance with some embodiments of the present disclosure;

FIG. 19C is a block diagram of an example system architecture for the example autonomous vehicle of FIG. 19A, in accordance with some embodiments of the present disclosure;

FIG. 19D is a system diagram for communication between cloud-based server(s) and the example autonomous vehicle of FIG. 19A, in accordance with some embodiments of the present disclosure;

FIG. 20 is a block diagram of an example computing device suitable for use in implementing some embodiments of the present disclosure; and

FIG. 21 is a block diagram of an example data center suitable for use in implementing some embodiments of the present disclosure.

### DETAILED DESCRIPTION

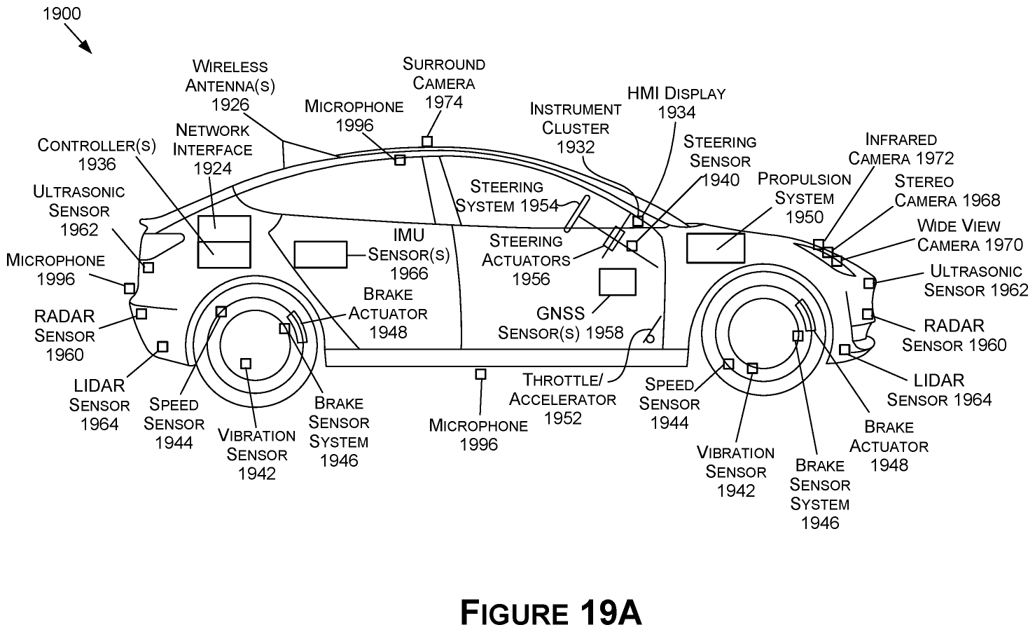

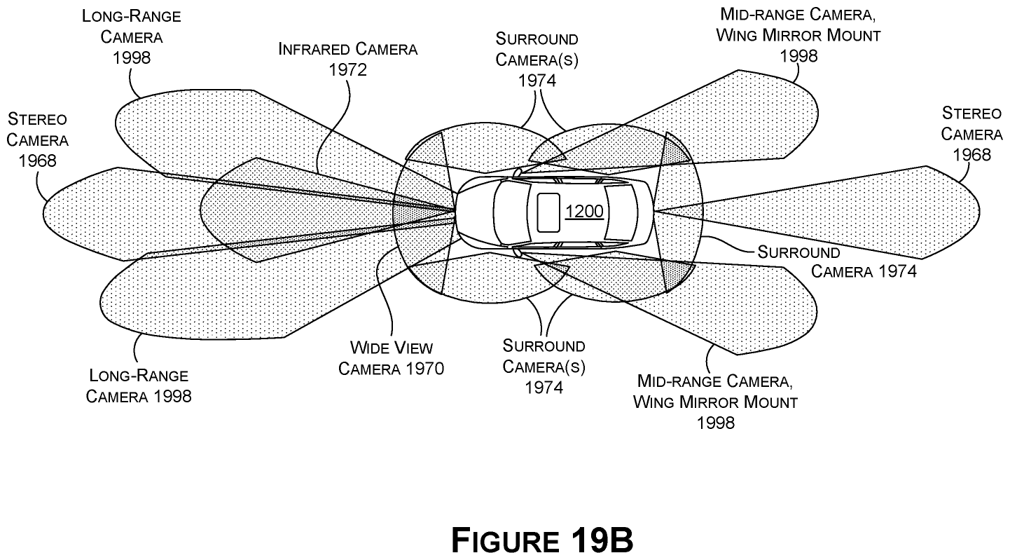

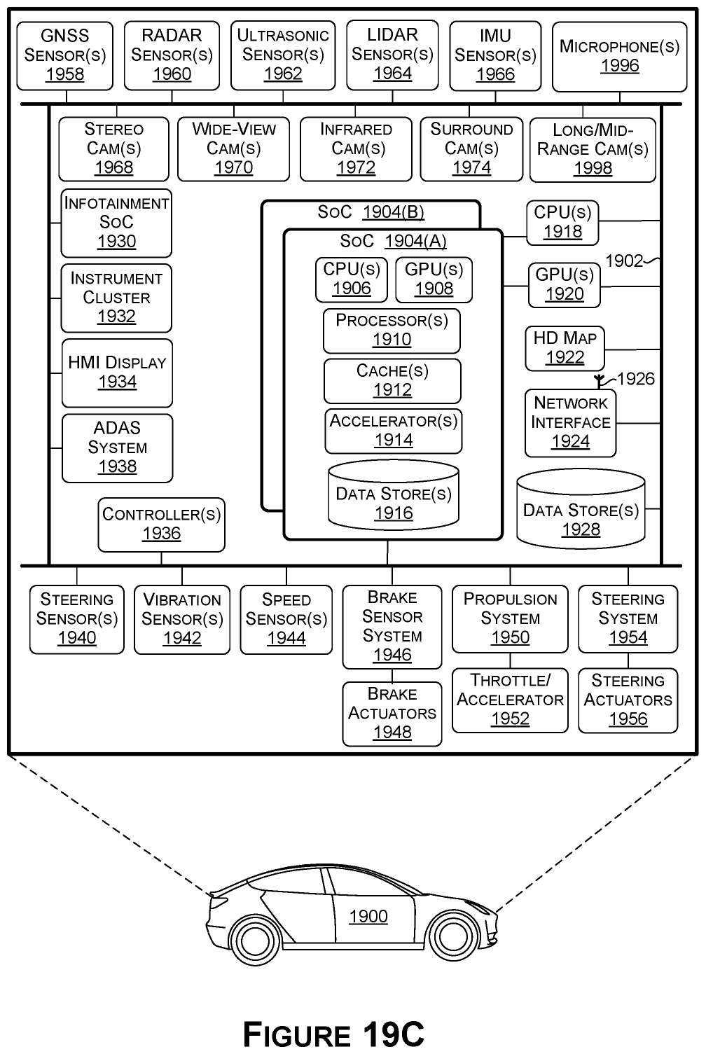

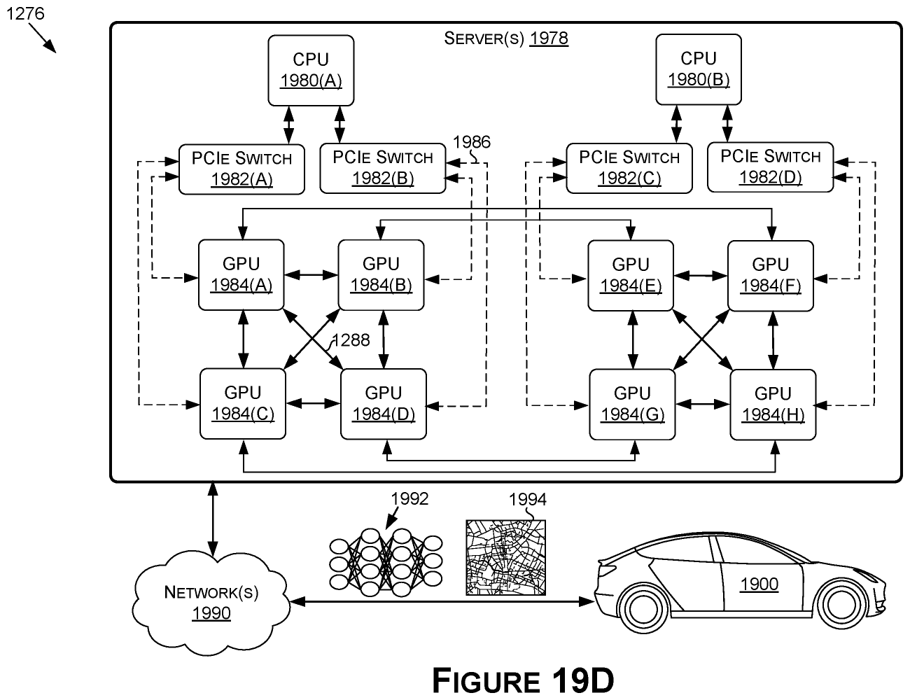

Systems and methods are disclosed related to lane inference and lane graph generation for autonomous systems and applications. For example, systems and methods are disclosed that use learning-based inferences of lane data to identify or detect instances of lanes for use in localization, navigation, and/or other uses by autonomous vehicles, semi-autonomous vehicles, robots, and/or other object or machine types. Although the present disclosure may be described with respect to an example autonomous or semi-autonomous vehicle or machine 1900 (alternatively referred to herein as “vehicle 1900” or “ego-machine 1900,” an example of which is described with respect to FIGS. 19A-19D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to lane inference and/or lane graph generation in autonomous or semi-autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where lane detection, localization, and/or navigation may be used.

At a high level, one or more DNNs may be used to infer lane data indicating a representation of a lane shape using sensor data from various vehicles to represent a three-dimensional (3D) environment. In some embodiments, the inferred lane data includes cross-section indicators that indicate cross-sections (e.g., a reference point with a left position and a right position) and/or connection indicators that indicate a lane channel connecting two locations (e.g., two lane portions). The inferred lane data, such as cross-sections and/or connection indicators, may be used to generate a lane graph. A lane graph generally refers to a data structure that represents lanes on a road and, in some cases, lane dividers (e.g., polyline represented as a solid line, a dashed line, a double line, etc.). As can be appreciated, a lane graph may be used, for example, to model the environment around a vehicle, facilitate localization, provide guidance for autonomous driving, etc.

In operation, sensor data generated by a fleet of ego-machines may be obtained. The sensor data may include polyline features (e.g., dividers, trajectories, and lane estimates) and point features (e.g., generated via RADAR and/or LiDAR). The sensor data may be processed into a format that is accepted by one or more deep neural networks (DNN) used to infer lane data indicating a lane. As one example, a DNN takes, as input, cell representations that represent cells or portions of a region. In this regard, cell representations that each represent a collection of points (e.g., representative of a polyline indicating a lane estimate, a divider, a trajectory) within a corresponding cell of a region of an environment scene are used to generate lane data indicating a lane(s). As such, the collected sensor data may be used to generate cell representations that represent the collected sensor data associated with cells.

To generate cell representations, in one embodiment, the collected sensor data may be projected to form a perspective view or a top-down representation of polylines and/or points. From the projected view, regions may be generated or extracted (e.g., 100 meters by 100 meters). Generating regions of suitable size enables a more efficient implementation as machine learning models may not be able to efficiently process data for an entire geographical region.

Thereafter, the region may be divided into cells (e.g., overlapping areas larger than a grid portion of a grid corresponding with the region), thereby facilitating a more efficient lane inference. For each cell, a set of points within the cell may be identified from a point cloud (e.g., an aggregate point cloud that aggregates points associated with polylines and points generated via RADAR and/or LiDAR). In embodiments, each point in the point cloud may be represented via a vector embedding that represents the point and attribute values for attributes associated with the point (e.g., point type, point position, tangent, etc.). In some implementations, for each point, or a portion thereof, a local coordinate position relative to the cell may be determined and/or an encoded position may be determined (e.g., Fourier encoded positional information). Such positional information may be aggregated with the other attributes associated with the point such that an augmented vector embedding results. The augmented vector embeddings may then be aggregated for the points within the cell to generate a cell representation for the cell.

In some embodiments, in accordance with generating cell representations for cells associated with a region of an environment scene, the cell representations may be provided, as input, to one or more DNNs for processing to generate lane data. In embodiments, a DNN for use in generating lane data includes encoder and decoder components (e.g., implemented using a transformer architecture). Encoding may be performed to take the cell representations as input and generate a latent representation for the region. In one embodiment, a hierarchical encoder is used to generate the latent representation for the region. In this regard, a cell encoder (e.g., including cross-attention and multiple self-attention units) is used to extract features and generate cell latent representations, and a global encoder (e.g., including multiple self-attention units) is used to relate the cell latent representations to one another and generate a region latent representation representing the region.

Based on the latent representation for the region, one or more decoder components may infer or generate lane data. In some embodiments, inferred lane data may include cross-section indicators that indicate cross-sections (e.g., a reference point with a left position and a right position) and/or connection indicators that indicate a lane channel connecting two locations. In some implementations, a cross-section decoder may be used to infer cross-section indicators, and a connection decoder may be used to infer connection indicators. In other embodiments, a single decoder may be used to infer lane data for use in generating a lane graph. In this regard, the decoder may function to generate or output lane data that specifies a geometry for a lane (e.g., pair of Bezier curves or lane edges).

In accordance with inferring a lane(s) via the lane data, the lane data, such as cross-section indicators and/or connection indicators, may be used to generate a lane graph. A lane graph may be implemented using any suitable data structure that represents lanes on a road and, in some cases, lane dividers (e.g., polyline represented as a solid line, a dashed line, a double line, etc.). For example, at a high level, the lane data may be projected back to the environment scene (e.g., global map view) to generate a lane graph. The post-processing techniques employed to generate the lane graph from the inferred lane data may depend on the manner in which the lane data is represented by one or more decoders. As can be appreciated, a lane graph may be used, for example, to model the environment around a vehicle or other ego-machine, facilitate localization, provide guidance for autonomous driving, etc.

As such, the techniques described herein may be used to infer or detect lanes and/or generate lane graphs therefrom. Thereafter, the generated lane graphs may be provided to an autonomous or semi-autonomous vehicle drive stack to aid in the performance in one or more operations related to localization, safe planning, and/or control of the vehicle. As such, detected lanes may aid an autonomous or semi-autonomous vehicle in navigating a physical environment, and specifically may aid in lane inference using sensor data from multiple vehicles for more accurate and reliable lane detection and navigation therefrom. Unlike conventional approaches, various embodiments provide a way to detect lanes and/or generate lane graphs using various types of sensor data collected from multiple vehicles, thereby allowing for a more precise lane detection than in conventional methods. Further, various embodiments detect lanes and/or generate lane graphs using a DNN(s) (e.g., implemented using a transformer architecture having various encoder and decoder components) in an offline manner, thereby reducing utilization of computing resources, particularly computing resources used onboard vehicles.

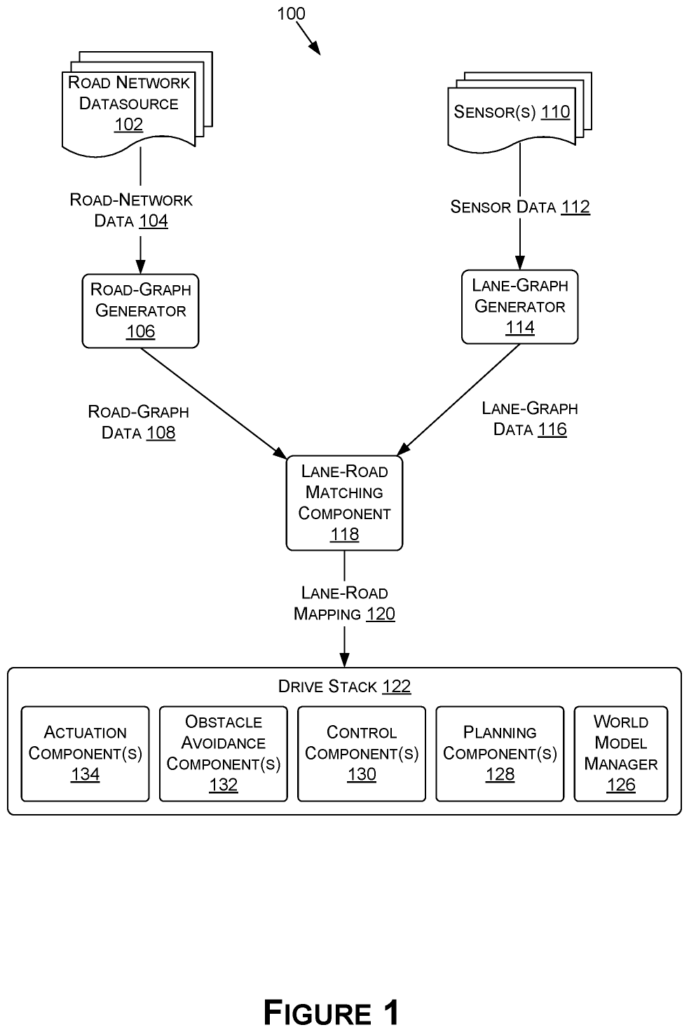

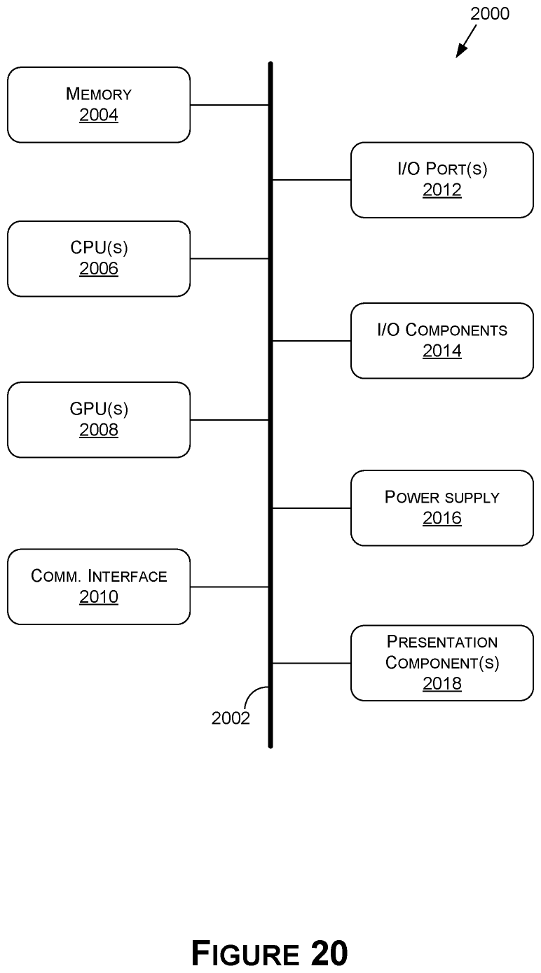

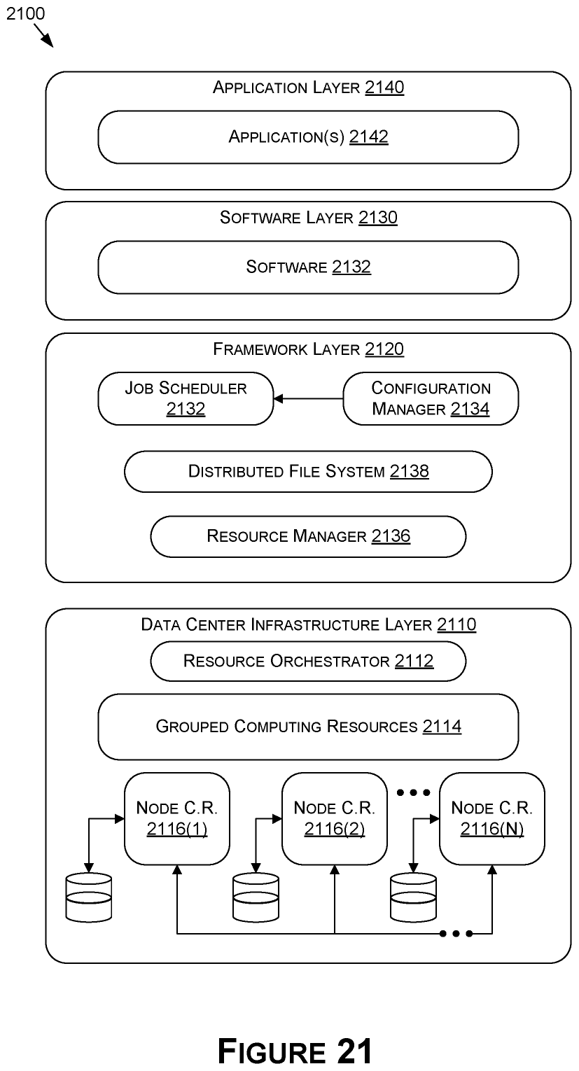

With reference to FIG. 1, FIG. 1 is a data flow diagram illustrating an example process 100 for a lane graph generation system, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1900 of FIGS. 19A-19D, example computing device 2000 of FIG. 20, and/or example data center 2100 of FIG. 21.

At a high level, the process 100 uses a lane graph generation component 108 which may include one or more machine learning models configured to infer lanes (e.g., lane data) and/or generate lane graphs based on sensor data 102 of a three dimensional (3D) environment. The sensor data 102 may be pre-processed by an input generator 104 into input data 106 that has a format that the lane graph generation component 108 is configured to accept and process, and the input data 106 may be fed into the lane graph generation component 108 to infer lanes and/or generate lane graph(s) 115 in the 3D environment.

In some embodiments, lane inference and/or lane graph generation may be performed using sensor data 102 from any number and any type of sensor, such as, without limitation, LiDAR sensors, RADAR sensors, cameras, and/or other sensor types such as those described below with respect to the autonomous vehicle 1900. For example, the sensor(s) 101 may include one or more sensor(s) 101 of an ego-machine—such as RADAR sensor(s) 1960 of the autonomous vehicle 1900—and the sensor(s) 101 may be used to generate sensor data 102 that represents perceptions in the 3D environment in association with an ego-machine(s) as well as objects in the 3D environment around the ego-machine(s). In accordance with embodiments described herein, the sensor data 102 is collected in association with any number of ego-machines. Using multiple eco-machines to collect sensor data 102 enables a more robust and accurate lane inference and, as such, lane graph.

The sensor data 102 may include various types of data. By way of example, and not limitation, sensor data 102 may include data that represents polyline features and point features. Polyline features include, for example, dividers, trajectories (e.g., ego trajectories and/or non-ego trajectories), and lane estimates. A divider generally refers to lines on the road (e.g., painted on the road). Dividers may be represented in dashed lines, solid lines, or other road boundaries. Trajectories generally refer to a path of motion (e.g., of a vehicle). An ego trajectory refers to a trajectory associated with a particular ego-machine having the sensor(s) detecting the sensor data. In some cases, ego trajectory includes output of an ego-motion module. A non-ego trajectory generally refers to a trajectory associated with other machines external to the particular ego-machine having the sensor(s) detecting the sensor data. For example, a vehicle may operate using a perception system that detects and tracks vehicles around the particular vehicle. As such, the non-ego trajectory represents the path of movement for a vehicle(s) external to the sensing vehicle. Lane estimates generally refer to estimates of lanes (also referred to as pathnet lane predictions). Lane estimates generally estimate the lane geometries based on images.

Point features represent various objects in a static position or point, such as traffic lights, signs, road markings, radar reflection intensity, and/or the like. The point features provide an indication of a general structure of an environment. Point features may be recognized by various types of sensors 101, such as RADAR, LiDAR, images (e.g., RBG images from one or more cameras mounted around an ego-machine), ultrasonic data, and/or the like. Taking LiDAR data as an example, point features may be generated using LiDAR data (e.g., sensor data 102) from one or more LiDAR sensors (e.g., sensor(s) 101). Generally, a LiDAR system may include a transmitter that emits pulses of laser light. The emitted light waves reflect off of certain objects and materials, and one of the LiDAR sensors may detect these reflections and reflection characteristics such as bearing, azimuth, elevation, range (e.g., time of beam flight), intensity, reflectivity, signal-to-noise ratio (SNR), and/or the like. Reflections and reflection characteristics may depend on the objects in the environment, speeds, materials, sensor mounting position and orientation, etc. Firmware associated with the LiDAR sensor(s) may be used to control LiDAR sensor(s) to capture and/or process the sensor data 102, such as reflection data from the sensor's field of view. Point features may also be generated using RADAR data (e.g., sensor data 102) from one or more RADAR sensors (e.g., sensor(s) 101). Generally, a RADAR sensor may provide imaging, detecting, ranging, tracking, and sensing of a drive location. RADAR may be in the form of an impulse RADAR or a frequency-modulated continuous wave (FMCW) RADAR.

Generally, the sensor data 102 may include raw sensor data, point cloud data (e.g., LiDAR or RADAR point clouds), and/or the like. For example, point clouds may be used to represent various point features (e.g., traffic lights, signs, road markings, radar reflection intensity, etc.) A point cloud, such as a RADAR point cloud, generally provides a representation of measured 3D points. In some embodiments, sensor data in the form of point features or a particular type of point feature are represented in one or more point clouds.

The input generator 104 may process the sensor data 102 into a format that the lane graph generation component 108 accepts (e.g., the input data 106). As described, the sensor data 102 may be collected from multiple vehicles to generate a more accurate lane inference and/or lane graph. In some implementations, sensor data associated with a particular geographic scene may be obtained (e.g., via a query for sensor data associated with a geographic location to obtain data from vehicles that have driven in that geographic location). The geographic scene may correspond with any sized area (e.g., a city, a zip code, a mile-by-mile grid, etc.) and is not intended to be limited herein. In accordance with collecting sensor data 102, in some cases, the sensor data 102 may be placed in a single coordinate system, such as a global coordinate system.

In embodiments, the input generator 104 may project the collected sensor data (e.g., the measured 3D points) to form a projection image representing any suitable view of the 3D environment (e.g., perspective, orthographic), having any number of channels (e.g., a single channel image, a multi-channel image or tensor) representing any characteristic(s) of the sensor data 102 (e.g., projected position of a measured 3D point or polyline, one or more reflection characteristics, image data such as pixel color, etc.). In some embodiments that use a perspective projection, any suitable perspective projection may be used (e.g., spherical, cylindrical, pinhole, etc.). In some cases, the type of projection may depend on the type of sensor. By way of non-limiting example, for spinning sensors, a spherical or cylindrical projection may be used. In some embodiments, for a time-of-flight camera (e.g., Flash-LiDAR), a pinhole projection may be used. In some embodiments, a different sensor(s) 101 (whether the same type or a different of sensor) may be used to generate different modalities of sensor data 102 (e.g., LiDAR range images, camera images, etc.) having the same (e.g., perspective) view of the 3D environment in a common image space, and sensor data 102 from the different sensors 101 or sensor modalities may be stored in different channels of a multi-channel image or tensor. These are meant simply as examples, and other variations are contemplated within the scope of the present disclosure.

Returning to FIG. 1, in embodiments, the input generator 104 may generate region representations associated with the projection image (e.g., corresponding with a geographic scene). In this regard, representations of various regions within a geographic scene may be generated. In this way, a geographic scene may be divided or segmented into regions of a smaller size as compared to the geographic scene. In some cases, the regions are overlapping regions within the projection image. The regions may be of any size suitable for implementations of the present technology. By way of example only, overlapping regions of 100 meters by 100 meters may be generated or extracted from the projection image. Using region representations to represent regions of suitable size for a geographical scene enables a more efficient implementation as machine learning models may not be able to efficiently process data for an entire geographic scene.

In accordance with identifying or designating a region(s) of a geographic scene, the input generator 104 may generate a region representation(s) for the region(s). In embodiments, a region may be represented in any number of ways. As one example, a region may be represented using points, or point representations, to represent sensor data 102 associated with various polyline features and/or point features, identified via a sensor(s) 101, that correspond with the region. The points may be structured in the form of a point cloud. As described, in some cases, the point features may be input in the form of a point cloud(s) (e.g., a feature point cloud). In other cases, the input generator 104 may generate one or more point clouds for various point features associated with a region.

To obtain a set of points associated with polylines for a region, the polylines of the region may be deconstructed into points, also referred to as polyline points. As one example, the polylines positioned within a region are collected. In some cases, polyline features are converted into a collection of points by sub-sampling the polylines at regular intervals (e.g., 2 meters). In this regard, collected polyline features may be resampled at fixed steps. The polyline features in the region may then be converted into a point cloud of the resampled vertices, thereby representing polylines in the region via a polyline point cloud.

In some embodiments, an aggregate point cloud is generated to represent a region via a single point cloud. To this end, the polyline point cloud for a region may be merged with any feature point cloud for the region. For example, a generated polyline point cloud for a region may be merged with a RADAR and/or LiDAR point cloud associated with the particular region, if available, to generate an aggregate point cloud associated with the particular region.

For various points in a point cloud, such an aggregate point cloud, the input generator 104 may generate point representations to represent the corresponding points. A point representation for a point may include various attributes associated with the point. For example, for each point, or a selected set of points, in an aggregate point cloud, the input generator 104 may identify various attributes to store as a point representation. In this way, a point (e.g., in the point cloud) may be represented in a manner that includes various attributes associated with the corresponding point. Various attributes that may be identified include, for example, a point category, a point position, a tangent, a distance, and left and/or right widths. A point category generally represents a category or type of point. For example, a point category may indicate if the point is related to a divider, an ego trajectory, a non-ego trajectory, a lane estimation, a sign, etc. A point position generally refers to a position of a point. A point position may be represented in 2D coordinates of the point. For example, a point position may be indicated using raw x and y coordinates and/or x and y coordinates associated of a bird's eye view. In this way, the input generator 104, or other component, may convert global coordinates to region local coordinates that represent coordinates local to or relative to the region. A tangent may refer to a line direction for polylines or facing direction for signs, traffic lights, poles, etc. In this way, a tangent may refer to a tangent at the vertex with respect to a corresponding input polyline. A distance may refer to a distance to the ego vehicle from which a particular point was perceived. For example, a distance may be used to represent a vehicle trajectory relative to a divider. A left and/or right width may be used to indicate lane width or channel-like input (e.g., generated from lane estimates).

In some embodiments, a point representation for a point is in the form of a vector embedding. In this way, a vector embedding is encoded or generated for each point in the point cloud. The vector embedding may include a set of attributes for a point, such as, for example, a point category, a point position, a tangent, a distance, and left and/or right widths, as described above. In cases in which particular types of attributes are not identified, the corresponding values may be set to zero. For instance, in cases in which lane estimates are not provided as input, these values may be set to zero.

In accordance with generating point representations associated with points in a region, a set of point representations for the region (e.g., vector embeddings for each point associated with a region) may be used to generate a region representation. In some cases, a point representation for each point in a region is aggregated to represent the region. In other cases, a subset of points in a region is used to represent the region. The subset of points may be selected in any number of ways, such as, a random sampling, an interval sampling, etc.

To facilitate a more efficient lane inference and/or lane generation, the lane graph generation system 108 may take, as input, cell representations. In particular, inferring lanes using a region representation as input, such as a region representation associated with a region of a geographical scene, may require a significant amount of memory due to the manner in which transformers operate. As such, to simplify processing, implementations described herein process smaller areas, referred to herein as cells, which may then be organized among one another in a transformer model.

As such, in some embodiments, the input generator 104 may be configured to generate cell representations. A cell refers to a portion of a region within a geographic scene. Generally, the cells represent portions of a grid corresponding with a region of a geographic scene, such that each cell is rectangular in shape, but the cells may be represented in any of a number of shapes and is not intended to be limited to a rectangular shape. A cell representation refers to a representation of a cell. In this regard, representations of various cells within a region may be generated. As such, a region may be divided or segmented (e.g., via the input generator 104) into cells of a smaller size as compared to the region. The cells may be of any size suitable for implementations of the present technology. By way of example only, cells may be a size of two meters by two meters, or any other appropriate size. In some embodiments, cells that are an enlarged or dilated portion associated with the grid are used. Using dilated cells may provide collectively exhaustive and overlapping rectangular cells laid out on a grid.

In accordance with identifying or designating a cell(s) of a region, the input generator 104 may generate a cell representation(s) for the cell(s). In embodiments, a cell may be represented in any number of ways. As one example, a cell may be represented using points, or point representations, to represent sensor data 102 associated with various polyline features and/or point features, identified via a sensor(s) 101, corresponding with the cell. In this way, a cell representation includes points representations for a subset of points that correspond with the cell, (e.g., dilated cell). For instance, for a cell, a set of point representations (e.g., vector embeddings) associated with a set of points in the cell are aggregated or used to generate a cell representation. Stated differently, for a cell, a set of points in a point cloud that correspond with a cell are obtained. In some cases, each point representation corresponding to a cell may be used to generate a cell representation. In other cases, a portion or subset of point representations may be used to generate a cell representation. For example, in some cases, point representations associated with a particular set of points may be used to generate a cell representation, thereby resulting in a cell representation of a fixed size (e.g. of a vector embedding representing the cell). Such a portion or subset of point representations may be selected in any number of ways, such as a random selection, a distributed selection, etc.

In some embodiments, the input generator 104 may include or append attributes or data in association with the point representations corresponding with the cell representation. For example, in some cases, a point representation in a cell representation may be augmented to include a cell local coordinate for a point. A cell local coordinate for a point generally reflects a local coordinate of a point relative to a cell. In this way, the input generator 104, or other component, may convert a global coordinate and/or region local coordinate for a point to a cell local coordinate that represent a coordinate local to or relative to the cell. Such a cell local coordinate for a point may be appended as an attribute to the point representation or used to replace positional information within the point representation. A cell local coordinate for a point may be based on any origin, such as the center of the cell, a corner of the cell, etc.

As another example, in some cases, a point representation in a cell representation may be augmented to include a Fourier encoded position. In this way, the input generator 104 may generate a Fourier encoded position for a point included in the cell representation. A Fourier encoded position generally represents a position of a point in a sequence or image using a set of sinusoidal functions. In some examples, a Fourier encoding converts a value (e.g., position or coordinate) to a 16-dimensional vector to represent the value. A Fourier encoded position may be generated using any of a number of implementations, such as a learnable Fourier features for multi-dimensional spatial positional encoding implementation or a rethinking positional encoding implementation. A global coordinate, a region local coordinate, and/or a cell local coordinate may be used to generate a Fourier encoded position. In some cases, such a Fourier encoded position for a point may be appended as an attribute to the point representation or used to replace positional information within the point representation.

In accordance with generating a cell representation or set of cell representations for a cell(s) associated with a region, the input generator 104 provides the cell representation(s) as input data 106 to the lane graph generation component 108. At a high level, the lane graph generation component 108 may include one or more machine learning models configured to infer lanes using the input data 106. Thereafter, the lane inferences may be used to generate a lane graph(s) 115.

The lane graph generation component 108 may take on various forms. As one example, the lane graph generation component 108 may include one or more machine learning models that generate lane inferences. The machine learning model(s) may be in the form of a deep neural network(s), for example, in the form of a transformer. As described herein, the transformer may include an encoder(s) that transforms the input data 106 into a lower dimensional representation, a decoder(s) that reconstructs the output data from that lower-dimensional representation. The transformer model may use attention (e.g., cross-attention and/or self-attention) to learn context and dependencies between input and output sequences. In one embodiment, the lane graph generation component 108 includes a hierarchical encoder, including a cell encoder and a region encoder. In one embodiment, a hierarchical encoder may be used to generate the latent representation for the region. In this regard, a cell encoder (e.g., including cross-attention and multiple self-attention units) may be used to extract features and generate cell latent representations, and a region encoder (e.g., including multiple self-attention units) may be used to relate the cell latent representations to one another and generate a latent representation for the region, also referred to as a region latent representation.

Based on the latent representation for a region, one or more decoder components may infer a lane or generate lane data. Lane data generally provides an indication or inference of a lane. As described, lane data may include cross-section indicators that indicate cross-sections (e.g., a reference point with a left position and a right position) associated with a lane, connection indicators that indicate a lane channel connecting two locations associated with a lane, and/or edge indicators that indicate an edge(s) or geometry of a lane. In one embodiment, a cross-section decoder may be used to infer cross-section indicators, and a connection decoder may be used to infer connection indicators. In another embodiment, a single decoder, such as an edge decoder, may be used to infer lane data for use in generating a lane graph. For example, the decoder may function to generate or output lane data that specifies a geometry for a lane (e.g., pair of Bezier curves or lane edges).

In accordance with inferring a lane(s) via the lane data, the lane data may be used to generate a lane graph(s) 115. For example, at a high level, the lane data may be projected back to the environment scene (e.g., global map view) to generate a lane graph. As can be appreciated, the particular post-processing techniques employed to generate the lane graph may depends on the particular decoder utilized and/or lane data output by the decoder(s), as described more fully herein.

In embodiments described herein, lane inference and/or lane graph generation may be performed in an offline manner. In this way, computing resources that would otherwise be used to infer lanes and/or generate lane graphs in real time are conserved.

Continuing with FIG. 1, the lane graph generation component 108 may identify detected lane graph(s) 115. In some embodiments, positional values that are not already in 3D world coordinates may be converted to 3D world coordinates, and/or may be provided for use by the vehicle 1900 of FIGS. 19A-19D in performing one or more operations, such as localization, navigation, and/or others. For example, a representation of the detected lane graph(s) 115 may be used by control component(s) of the vehicle 1900, such as an autonomous driving software stack 122 executing on one or more components of the vehicle 1900 of FIGS. 19A-19D (e.g., the SoC(s) 1904, the CPU(s) 1918, the GPU(s) 1920, etc.). For example, the vehicle 1900 may use this information (e.g., instances of obstacles) to localize its position in a map, to navigate, plan, or otherwise perform one or more operations (e.g., obstacle or protuberance avoidance, lane keeping, lane changing, merging, splitting, adapting a suspension system of the ego-machine to match the current road surface, applying an early acceleration or deceleration based on an approaching surface slope, mapping, etc.) within the environment.

In some embodiments, the lane graph(s) 115 may be used by one or more layers of the autonomous driving software stack 122 (alternatively referred to herein as “drive stack 122”). The drive stack 122 may include a sensor manager (not shown), perception component(s) (e.g., corresponding to a perception layer of the drive stack 122), a world model manager 126, planning component(s) 128 (e.g., corresponding to a planning layer of the drive stack 122), control component(s) 130 (e.g., corresponding to a control layer of the drive stack 122), obstacle avoidance component(s) 132 (e.g., corresponding to an obstacle, or collision avoidance layer of the drive stack 122), actuation component(s) 134 (e.g., corresponding to an actuation layer of the drive stack 122), and/or other components corresponding to additional and/or alternative layers of the drive stack 122. The process 100 may, in some examples, be executed at least in part by or in association with the perception component(s), which may feed up the layers of the drive stack 122 to the world model manager, as described in more detail herein.

The sensor manager may manage and/or abstract sensor data from the sensors of the vehicle 1900. For example, and with reference to FIG. 19C, the sensor data may be generated (e.g., perpetually, at intervals, based on certain conditions) by the LIDAR sensor(s) 1964, the RADAR sensor(s) 1960, the ultrasonic sensor(s) 1962, the stereo camera(s) 1968, other camera(s), and/or other sensors). The sensor manager may receive the sensor data from the sensors in different formats (e.g., sensors of the same type may output sensor data in different formats), and may be configured to convert the different formats to a uniform format (e.g., for each sensor of the same type). As a result, other components, features, and/or functionality of the autonomous vehicle 1900 may use the uniform format, thereby simplifying processing of the sensor data. In some examples, the sensor manager may use a uniform format to apply control back to the sensors of the vehicle 1900, such as to set frame rates or to perform gain control. The sensor manager may also update sensor packets or communications corresponding to the sensor data with timestamps to help inform processing of the sensor data by various components, features, and functionality of an autonomous vehicle control system.

A world model manager 126 may be used to generate, update, and/or define a world model. The world model manager 126 may use information generated by and received from the perception component(s) of the drive stack 122 (e.g., the locations of detected obstacles). The perception component(s) may include an obstacle perceiver, a path perceiver, a wait perceiver, a map perceiver, and/or other perception component(s). For example, the world model may be defined, at least in part, based on affordances for obstacles, paths, and wait conditions that may be perceived in real-time or near real-time by the obstacle perceiver, the path perceiver, the wait perceiver, and/or the map perceiver. The world model manager 126 may continually update the world model based on newly generated and/or received inputs (e.g., data) from the obstacle perceiver, the path perceiver, the wait perceiver, the map perceiver, and/or other components of the autonomous vehicle control system.

The world model may be used to help inform planning component(s) 128, control component(s) 130, obstacle avoidance component(s) 132, and/or actuation component(s) 134 of the drive stack 122. The obstacle perceiver may perform obstacle perception that may be based on where the vehicle 1900 is allowed to drive or is capable of driving (e.g., based on the location of the drivable or other navigable paths defined by avoiding detected obstacles in the environment and/or detected protuberances in the road surface), and how fast the vehicle 1900 can drive without colliding with an obstacle (e.g., an object, such as a structure, entity, vehicle, etc.) that is sensed by the sensors of the vehicle 1900.

The path perceiver may perform path perception, such as by perceiving nominal paths that are available in a particular situation. In some examples, the path perceiver may further take into account lane changes for path perception. A lane graph may represent the path or paths available to the vehicle 1900, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information. In some embodiments, the path perceiver may take into account the detected lane graph(s) 115. For example, the path perceiver may evaluate a reconstructed 3D road surface to identify lane changes and lane merges.

The wait perceiver may be responsible to determining constraints on the vehicle 1900 as a result of rules, conventions, and/or practical considerations. For example, the rules, conventions, and/or practical considerations may be in relation to a 3D road surface, traffic lights, multi-way stops, yields, merges, toll booths, gates, police or other emergency personnel, road workers, stopped buses or other vehicles, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver. In some embodiments, the wait perceiver may take into account the detected lane graph(s) 115. For example, the wait perceiver may evaluate a reconstructed 3D road surface to identify an approaching lane merge and determine to apply and/or apply an early acceleration or deceleration to accommodate the approaching lane merge.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 1900 of static or stationary infrastructure objects and obstacles. The map perceiver may also generate information for the wait perceiver and/or the path perceiver, for example, such as to determine which light at an intersection has to be green for the vehicle 1900 to take a particular path.

In some examples, information from the map perceiver may be sent, transmitted, and/or provided to server(s) (e.g., to a map manager of server(s) 1978 of FIG. 19D), and information from the server(s) may be sent, transmitted, and/or provided to the map perceiver and/or a localization manager of the vehicle 1900. The map manager may include a cloud mapping application that is remotely located from the vehicle 1900 and accessible by the vehicle 1200 over one or more network(s). For example, the map perceiver and/or the localization manager of the vehicle 1900 may communicate with the map manager and/or one or more other components or features of the server(s) to inform the map perceiver and/or the localization manager of past and present drives or trips of the vehicle 1900, as well as past and present drives or trips of other vehicles. The map manager may provide mapping outputs (e.g., map data) that may be localized by the localization manager based on a particular location of the vehicle 1900, and the localized mapping outputs may be used by the world model manager 126 to generate and/or update the world model.

The planning component(s) 128 may include a route planner, a lane planner, a behavior planner, and a behavior selector, among other components, features, and/or functionality. The route planner may use the information from the map perceiver, the map manager, and/or the localization manager, among other information, to generate a planned path that may consist of GNSS waypoints (e.g., GPS waypoints), 3D world coordinates (e.g., Cartesian, polar, etc.) that indicate coordinates relative to an origin point on the vehicle 1900, etc. The waypoints may be representative of a specific distance into the future for the vehicle 1900, such as a number of city blocks, a number of kilometers, a number of feet, a number of inches, a number of miles, etc., that may be used as a target for the lane planner.

The lane planner may use the lane graph, object poses within the lane graph (e.g., according to the localization manager), and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph from a current edge in the lane graph to find the shortest path to the target point.

The behavior planner may determine the feasibility of basic behaviors of the vehicle 1900, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe).

The control component(s) 130 may follow a trajectory or path (lateral and longitudinal) that has been received from the behavior selector (e.g., based on the detected lane graph(s) 115) of the planning component(s) 128 as closely as possible and within the capabilities of the vehicle 1900. The control component(s) 130 may use tight feedback to handle unplanned events or behaviors that are not modeled and/or anything that causes discrepancies from the ideal (e.g., unexpected delay). In some examples, the control component(s) 130 may use a forward prediction model that takes control as an input variable, and produces predictions that may be compared with the desired state (e.g., compared with the desired lateral and longitudinal path requested by the planning component(s) 128). The control(s) that minimize discrepancy may be determined.

Although the planning component(s) 128 and the control component(s) 130 are illustrated separately, this is not intended to be limiting. For example, in some embodiments, the delineation between the planning component(s) 128 and the control component(s) 130 may not be precisely defined. As such, at least some of the components, features, and/or functionality attributed to the planning component(s) 128 may be associated with the control component(s) 130, and vice versa. This may also hold true for any of the separately illustrated components of the drive stack 122.

The obstacle avoidance component(s) 132 may aid the autonomous vehicle 1900 in avoiding collisions with objects (e.g., moving and stationary objects). The obstacle avoidance component(s) 132 may include a computational mechanism at a “primal level” of obstacle avoidance, and may act as a “survival brain” or “reptile brain” for the vehicle 1900. In some examples, the obstacle avoidance component(s) 132 may be used independently of components, features, and/or functionality of the vehicle 1900 that is required to obey traffic rules and drive courteously. In such examples, the obstacle avoidance component(s) may ignore traffic laws, rules of the road, and courteous driving norms in order to ensure that collisions do not occur between the vehicle 1900 and any objects. As such, the obstacle avoidance layer may be a separate layer from the rules of the road layer, and the obstacle avoidance layer may ensure that the vehicle 1900 is only performing safe actions from an obstacle avoidance standpoint. The rules of the road layer, on the other hand, may ensure that vehicle obeys traffic laws and conventions, and observes lawful and conventional right of way (as described herein).

In some examples, the drivable or other navigable paths and/or the detected lane graphs(s) 115 may be used by the obstacle avoidance component(s) 132 in determining controls or actions to take. For example, the drivable paths may provide an indication to the obstacle avoidance component(s) 132 of where the vehicle 1900 may maneuver without striking any objects, protuberances, structures, and/or the like, or at least where no static structures may exist.

In non-limiting embodiments, the obstacle avoidance component(s) 132 may be implemented as a separate, discrete feature of the vehicle 1900. For example, the obstacle avoidance component(s) 132 may operate separately (e.g., in parallel with, prior to, and/or after) the planning layer, the control layer, the actuation layer, and/or other layers of the drive stack 122.

As such, the vehicle 1900 may use this information (e.g., as the edges, or rails of the paths) to navigate, plan, or otherwise perform one or more operations (e.g. lane keeping, lane changing, merging, splitting, etc.) within the environment.

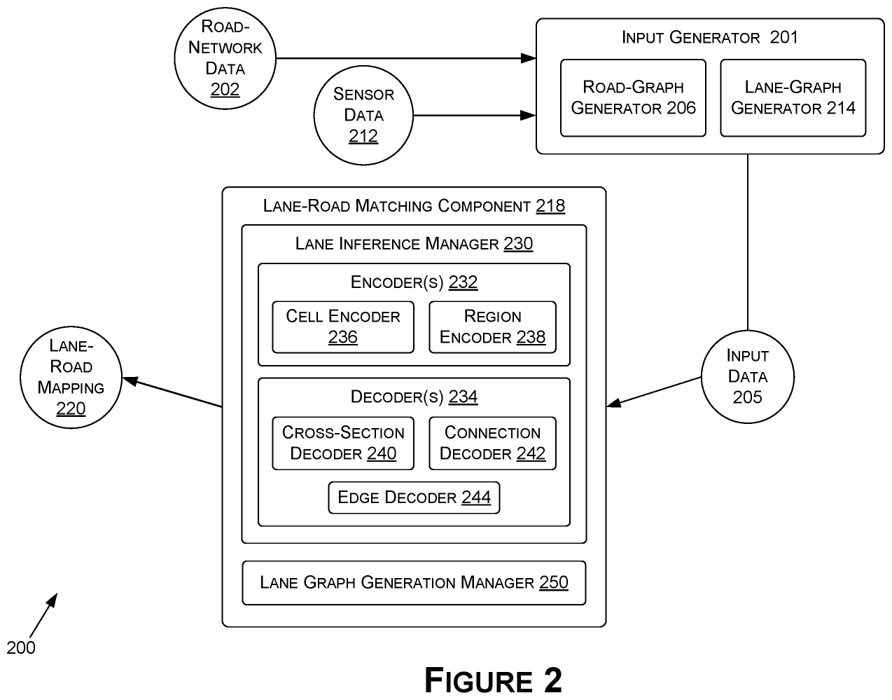

Turning now to FIG. 2, FIG. 2 is a data flow diagram illustrating an example process 200 for inferring lanes and generating lane graphs based on one or more machine learning models in the form of one or more DNNs, such as a transformer, in accordance with some embodiments of the present disclosure. In some embodiments, the process 200 represents a possible way for the lane graph generation component 108 of FIG. 1 to infer lanes using input data and/or generate lane graphs therefrom.

FIG. 2 illustrates an input generator 204 that processes the sensor data 202 into a format that the lane graph generation component 208 accepts (input data 206) and feeds the input data 206 into the lane graph generation component 208, which may generate one or more lane graph(s) 215. In embodiments corresponding to the illustration of FIG. 2, the input generator 204 includes a sensor data obtainer 220, a region representation generator 222, and a cell representation generator 224.

The sensor data obtainer 220 is generally configured to obtain sensor data 202. The sensor data 202 may include various types of data. By way of example, and not limitation, sensor data 202 may represent polyline features (e.g., dividers, trajectories, and lane estimates) and point features (lights, signs, road markings, radar reflection intensity, etc.). The sensor data 202 may be obtained or collected from multiple vehicles to generate a more accurate lane inference and/or lane graph. In some implementations, sensor data associated with a particular geographical scene may be obtained (e.g., via a query for sensor data associated with a geographical location to obtain data from vehicles that have driven in that geographical location). The geographical scene may correspond with any sized area or region and is not intended to be limited herein. In accordance with obtaining sensor data, the sensor data obtainer 220 may place the sensor data in a single coordinate system, such as a global coordinate system.

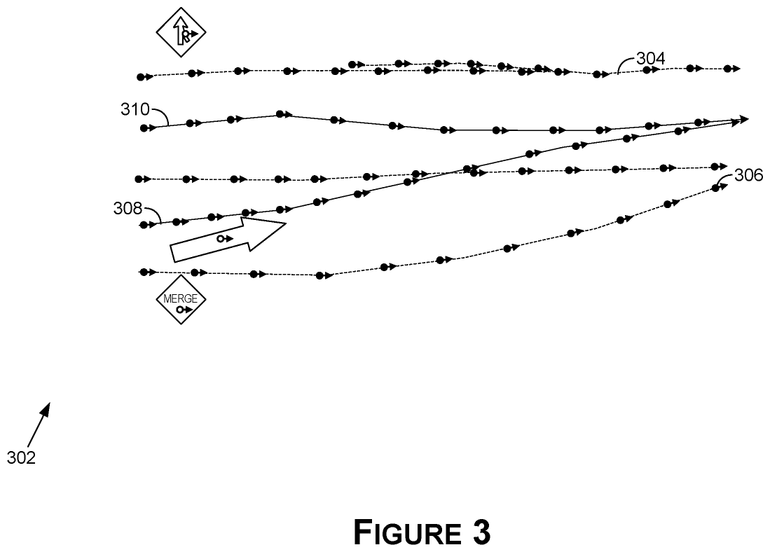

The region representation generator 222 is generally configured to generate region representations for regions of a geographic scene. As such, the region representation generator 222 may generate a geographic scene from the collected sensor data. For example, the region representation generator 222 may project the collected sensor data (e.g., the measured 3D points) to form a projection image representing any suitable view of the 3D environment (e.g., perspective, orthographic), having any number of channels (e.g., a single channel image, a multi-channel image or tensor) representing any characteristic(s) of the sensor data 202 (e.g., projected position of a measured 3D point or polyline, one or more reflection characteristics, image data such as pixel color, etc.). For example, and with reference to FIG. 3, the collected sensor data may be projected to form a perspective view or a top-down representation 302 of projected 3D locations of measured 3D points. As shown in FIG. 3, the top-down representation 302 may include the road edge 304, the lane divider 306, the ego trajectory 308, and the non-ego trajectory 310. As can be appreciated, the top-down representation 302 illustrated in FIG. 3 may be a portion of a top-down view of an environment scene. In some embodiments that use a perspective projection, any suitable perspective projection may be used (e.g., spherical, cylindrical, pinhole, etc.). In some cases, the type of projection may depend on the type of sensor.

In accordance with generating a geographic scene (e.g., top-down representation), the region representation generator 222 may divide the geographical scene into regions of a smaller size as compared to the geographical scene. In some cases, the region are overlapping regions of the projection image. The region may be of any size suitable for implementations of the present technology.

For a region, the region representation generator 222 may generate a region representation for the region. A region representation may be formatted in any number of ways. As one example, a region may be represented using points, or point representations, to represent sensor data 202 associated with various polyline features and/or point features within the region. In this regard, a region representation may be include a set of point representations representing various points (e.g., each point or a subset of points) within the region. The points may include feature points and/or polyline points. Polyline points may be derived from the polylines in the region. For example, polylines of the region may be deconstructed into points (e.g., by sub-sampling the polylines at regular intervals). In this regard, collected polyline features may be resampled at fixed steps.

A point representation for a point may include various attributes associated with the point. For example, for each point, or a selected set of points, in a region, the region representation generator 222 may identify various attributes to store as a point representation. In this way, a point (e.g., in a point cloud associated with the region) may be represented in a manner that includes various attributes associated with the corresponding point. Various attributes that may be identified include, for example, a point category, a point position, a tangent, a distance, and left and/or right widths. In some embodiments, a point representation for a point is in the form of a vector embedding. In this way, a vector embedding is encoded or generated for each point or a set of points in a point cloud. The vector embedding may include a set of attributes for a point, such as, for example, a point category, a point position, a tangent, a distance, and left and/or right widths, as described above. In cases in which particular types of attributes are not identified, the corresponding values may be set to zero. For instance, in cases in which lane estimates are not provided as input, these values may be set to zero.

In accordance with generating point representations associated with points in a region, a set of point representations for the region (e.g., vector embeddings for points associated with a region) may be used to generate the region representation. In some cases, a point representation for each point in a region is aggregated to represent the region. In other cases, a subset of points in a region is used to represent the region. The subset of points may be selected in any number of ways, such as a random sampling, an interval sampling, etc.

The cell representation generator 224 is generally configured to generate cell representations for cells of a region. As described, to facilitate a more efficient lane inference and/or lane generation, the lane graph generation system 208 may take, as input, cell representations. As such, implementations described herein process cells, which may then be organized among one another in a transformer model.

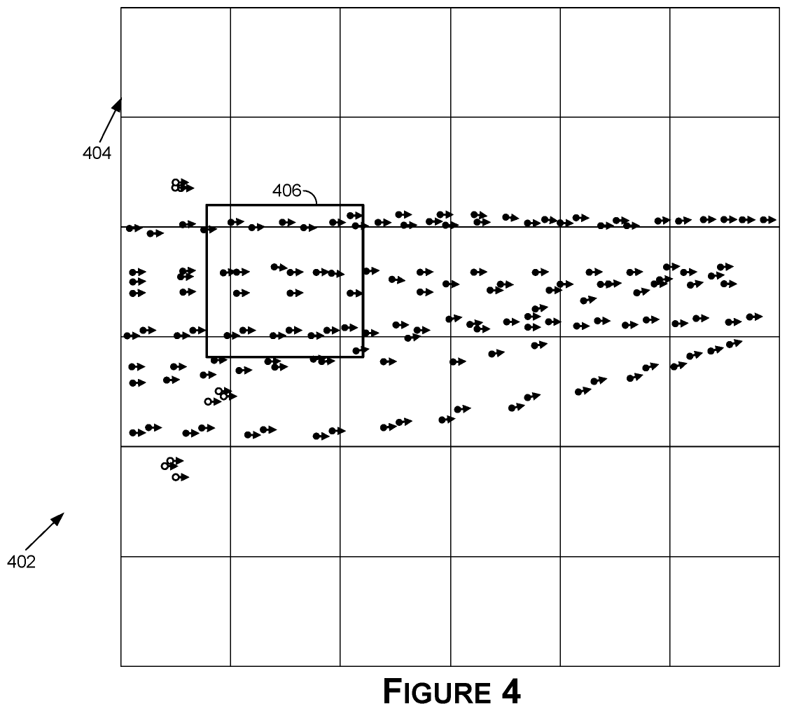

Accordingly, the cell representation generator 224 may divide or separate a region into cells. A cell refers to a portion of a region within a geographical scene. A region may be divided into any number of cells. In some embodiments, cells that enlarge or dilate a portion or unit associated with the grid are used. Using dilated cells provides collectively exhaustive and overlapping rectangular cells laid out on a grid. For example, and with reference to FIG. 4, FIG. 4 provides an example of a region 402. A grid 404 is used to shape the region 402 into rectangular portions or units. In this example, the grid is six by six resulting in 36 portions or units, but the grid may be divided into any number of grid units or be partitioned based on any particular size (e.g., two meters). As shown, cell 406, which may be referred to as a dilated cell, is an enlarged portion of the corresponding grid unit. Each cell within the region 402 may be an enlarged portion of the corresponding grid unit such that the cells overlap one another. Using such a dilated cell provides context that may be used to infer lanes and/or generate lane graphs.

Returning to FIG. 2, in accordance with identifying or designating a cell(s) of a region, the cell representation generator 224 may generate a cell representation(s) for the cell(s). In embodiments, a cell may be represented in any number of ways. As one example, a cell may be represented using points, or point representations, to represent sensor data 202 associated with various polyline features and/or point features identified via a sensor(s) in association with the cell. In this way, a cell representation includes points representations for a subset of points that correspond with the cell, or dilated cell. For instance, for a cell, a set of point representations (e.g., vector embeddings) associated with a set of points in the cell are aggregated or used to generate a cell representation. A cell representation, including the various point representations, may be in the form of a vector embedding, a tensor, and/or the like.

By way of example, and with reference back to FIG. 4, assume a cell representation is being generated for cell 406. In such a case, the cell representation may represent the points included within the boundary of the cell 406. For instance, a cell representation may include a point representation for each point in the cell 406. The points within the cell may correspond with different types of point features and/or polyline features, such as dividers, trajectories, lane estimates, etc. Further, as can be appreciated, the points within the cell may include aggregate data from multiple vehicles.

In some cases, each point representation corresponding to a cell may be used to generate a cell representation. In other cases, a portion or subset of point representations may be used to generate a cell representation. For example, in some cases, point representations associated with a particular set of points may be used to generate a cell representation, thereby resulting in a cell representation of a fixed size (e.g. of a vector embedding representing the cell). Such a portion or subset of point representation may be selected in any number of ways, such as a random selection, a distributed selection, etc. As one example, a random sampler may be used to randomly sample or select a set of points per cell. For instance, a random sampler may be used to identify a particular number of points of a divider point type, a particular number of points of a trajectory point type, a particular number of points of a lane estimate point type, etc.

In some embodiments, the cell representation generator 224 may include or append attributes or data in association with the point representations corresponding with the cell. For example, in some cases, the cell representation generator 224 may determine a cell local coordinate for a point and append the cell local coordinate as an attribute in the point representation. In this regard, the cell representation generator 224 may generate a cell local coordinate for a point from a global coordinate and/or region local coordinate associated with the point. As another example, in some cases, the cell representation generator 224 may determine a Fourier encoded position for a point and append the Fourier encoded position as an attribute in the point representation. In this way, the cell representation generator 224 may generate a Fourier encoded position for a point that generally represents a position of a point in a sequence or image using a set of sinusoidal functions.

In accordance with generating a cell representation or set of cell representations for a cell(s) associated with a region, the input generator 204 provides the cell representation(s) (e.g., vector embeddings) as input data 206 to the lane graph generation component 208. At a high level, the lane graph generation component 208 is generally configured to infer lanes using the input data 206 and, thereafter, use the lane inferences to generate a lane graph.

In the embodiment illustrated in FIG. 2, the lane graph generation component 208 includes a lane inference manager 230 and a lane graph generation manager 250. At a high level, the lane inference manager 230 is configured to manage lane inferences, and the lane graph generation manager 250 is configured to manage lane graph generation based on the inferred lanes.

In embodiments, the lane inference manager 230 includes one or more machine learning models to infer lanes. For example, one or more deep neural networks (DNNs) may be used to generate lane inferences. In embodiments, a DDN make take the form of a transformer for use in generating lane inferences. Accordingly, as illustrated in FIG. 2, the lane inference manager 230 includes encoder(s) 232 and decoder(s) 234.

The encoder(s) 232 generally takes, as input, the input data 206. As described herein, the input data 206 may be in the form of cell representations that represent cells of a region in a geographic scene. In embodiments, the encoder(s) 232 may take the cell representations associated with a region in a sequential process. In other embodiments, the encoder(s) 232 may take the cell representations associated with a region in a concurrent or aggregate manner.

The encoder(s) 232 is generally configured to generate a latent representation of a region (e.g., a portion of a geographic scene) using the set of cell representations associated with the region. At a high level, an encoder in a transformer is generally a neural network component that processes an input (e.g., input sequence) and produces a latent representation(s) (e.g., a vector), that captures the meaning and structure of the input. As described herein, the encoder(s) is generally configured to generate a latent representation of a region (e.g., in the form of a vector), also referred to herein as a region latent representation, that captures the meaning and structure of the cell representations corresponding with the region. In this way, the encoder(s) learns to map data from an original space to a latent space. Generally, a latent representation refers to a representation, produced for an input, that provides a simplified model (e.g., in lower-dimensional space) of the input data and captures key features or patterns and may be used to reconstruct output. In embodiments, a latent representation may capture visual features, such as shapes, colors, textures, structural properties, etc. In some cases, a latent representation represents one or more consolidated lanes or lane lines observed by various ego-machines. A latent representation may be in any number of forms, such as a vector.

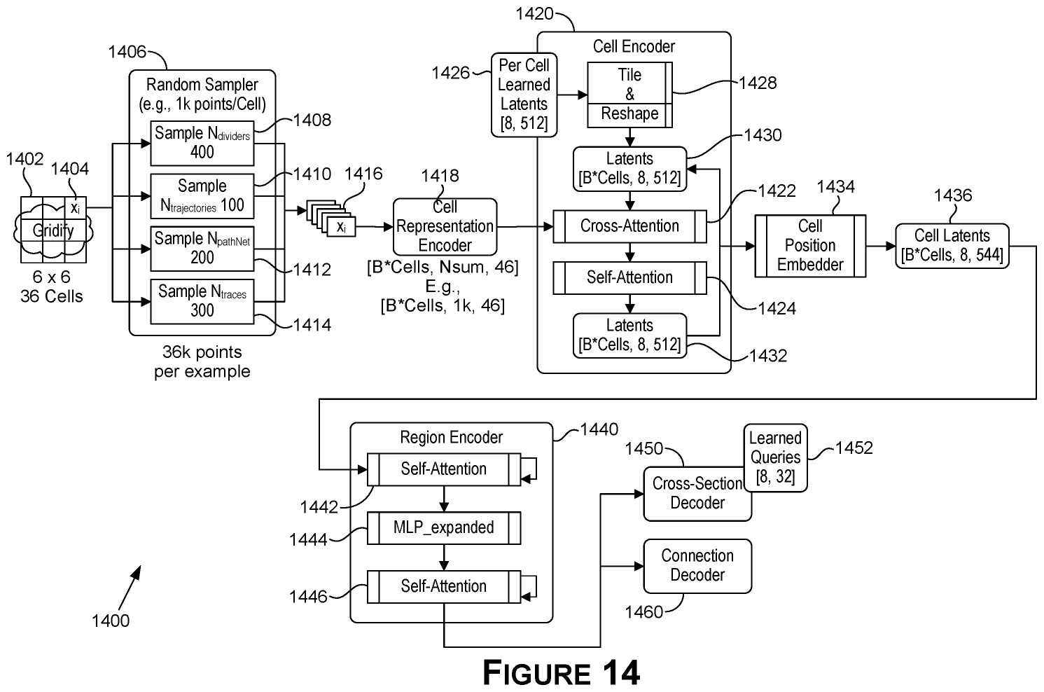

In some embodiments, and as illustrated, the encoder(s) 232 is in the form of a hierarchical structure. In this regard, the encoder(s) 232 includes a cell encoder 236 and a region encoder 238. The cell encoder 236 may be used to extract features and generate cell latent representations. The region encoder 238 may be used to relate the cell latent representations to one another and generate a region latent representation therefrom. In this regard, the cell latent representations generated via the cell encoder 236 may be provided as input to the region encoder 238, which uses the cell latent representations to generate a region latent representation representing the region. As described herein, each encoder component, such as cell encoder 236 and region encoder 238, may include multiple encoder blocks or units, which may perform self-attention or cross-attention on the input. One example of a hierarchical encoder structure is provided with reference to FIG. 14, which is described more fully below.

The decoder(s) 234 is generally configured to take, as input, output associated with the encoder and translate the data (e.g., vector) into output data, that is, a translated version of the input. The decoder(s) 234 may be in any number of forms and may include a cross-attention layer(s), a self-attention layer(s), and/or the like.

In embodiments, the decoder(s) 234 takes a region latent representation as input and uses the region latent representation to infer a lane or set of lanes. In this regard, based on the latent representation for a region, one or more decoder components may infer a lane(s) or generate lane data that represent a lane(s). As described, lane data output from a decoder(s) 234 may include cross-section indicators that indicate cross-sections (e.g., a reference point with a left position and a right position), connection indicators that indicate a lane channel connecting two locations, and/or edge indicators that indicate lane edges. In some embodiments, a cross-section decoder may be used to infer cross-section indicators, and a connection decoder may be used to infer connection indicators. In other embodiments, a single decoder, such as an edge decoder, may be used to infer lane edges for use in generating a lane graph. In this regard, the decoder may function to generate or output lane data that specifies a geometry for a lane (e.g., pair of Bezier curves or lane edges). Decoder(s) 234 may include a cross-section decoder 240, a connection decoder 242, and/or an edge decoder 244. In embodiments, decoders 240-244 illustrated herein may be implemented in various ways and combinations. For instance, in some cases, only a single decoder may be employed. By way of example, only a cross-section decoder 240 may be implemented.

As another example, only an edge decoder 244 may be implemented. In other cases, a combination of decoders may be used. For example, a combination of cross-section decoder 240 and connection decoder 242 may be implemented. In yet other cases, each decoder may be implemented. In such a case, the decoders may output different types of information, which may then be used (e.g., some or all) to generate a lane graph (e.g., use the data as an aggregate, average, highest ranked, etc.).

A cross-section decoder 240 is generally configured to generate cross-section indicators. A cross-section indicator refers to data that indicates a cross-section of a lane. In embodiments, cross-section data may include a reference point, a left position, and/or a right position to represent a cross-section of a lane. In some cases, a cross-section is defined as a data structure including left coordinates indicating a left edge of a lane and right coordinates indicating a right edge of the lane.

In some embodiments, the cross-section decoder 240 may be configured to predict whether a lane exists near a particular location (e.g., via an anchor point). If a lane is predicted to exist near a particular location, the cross-section decoder 240 may determine or generate cross-section indicators, such as a reference point indicating a center of a lane, a left position indicating a left edge of a lane, and/or a right position indicating a right edge of the lane. In determining or predicting whether a lane exists near a particular location (e.g. within a particular area of anchor box, within a predetermined distance from a particular location, etc.), a threshold value may be used (e.g., 0.5 during training and 0.8 during inference). For example, a confidence of a lane existing under 0.8 during inference may result in an invalid output or result, while a confidence of a lane existing above 0.8 during inference may result in a valid output or response. Upon attaining the threshold value for predicting a lane exists near a particular location, the cross-section indicators may be identified and/or output. Such cross-section indicators may be provided in various formats or types of values. As one example, center, left and right cross-section positions may be generated and/or output as float values.

To predict whether a lane exists near a particular location and/or generate cross-section indicators, the cross-section decoder 240 may use a cross-attention layer. A cross-attention layer generally refers to an attention component that combines different inputs. As one example, a cross-section decoder 240 may include a cross-attention multilayer perceptrons (MLPs) (e.g., a single cross-attention multilayer perceptrons). The MLP layer(s) may be used to convert the input into a desired output. MLPs may perform various types of tasks, such as classification tasks, regression tasks, etc. In this regard, a neural network architecture may use a single layer of cross-attention to combine two different inputs (e.g., input sequences) to predict whether a lane exists and/or generate cross-section data.

In operation, a cross-attention layer of a cross-section decoder 240 may process a set of queries indicating different locations along with the region latent representation (e.g., output by an encoder(s)). As such, in addition to the cross-section decoder 240 taking as input region latent representations (e.g., from the encoder), queries may also be obtained as input. A query may be a vector representation indicating what the decoder is searching for in the input. In embodiments, the query may represent or include a position, for example, in association with a cell, region, and/or environment scene (e.g., via an anchor point). Such a position may be represented in any of a number of ways, such as, for example, an x-coordinate and a y-coordinate. A query obtained as input by the cross-section decoder 240 may be a learned query. A learned query generally refers to a type of query that is not fixed, but is learned from the data during the training process. For example, a learned query may be a random vector (e.g., of 32 values) that, during training, is optimized to become meaningful to the model.

Any number of queries (e.g., learned query vectors) may be used as inputs (e.g., as an aggregate set of queries or a sequence of queries). In one embodiment, a number of queries may depend on the number of locations for which queries are submitted and/or the number of responses desired. For example, with regard to the locations, an anchor grid (e.g., a set of predefined bounding boxes) may be positioned to cover a region. In some cases, the anchor grid may cover an inference area of the region (e.g., a central area of the region). The inference area may be smaller in size than the size of the region, thereby enabling analysis with sufficient context around the anchor points. Assume an inference area of a region includes an 8 by 8 anchor grid, resulting in 64 grid locations for anchor points. In this regard, a query may be based on, or include, coordinates associated with an anchor point(s). For instance, an anchor point(s) may be used to encode positional information into a query. An anchor box may be a predefined bounding box within an anchor grid that represents a possible object location and scale. In one embodiment, a query may use any position of an anchor box, such as a center position (x,y) of an anchor box, as an anchor point to identify whether a lane is near or within the anchor point or anchor box (e.g., width and height) and/or determine cross-section indicators. Stated differently, the anchor point may refer to a location the cross-section decoder may use to determine if the location is valid, thereby representing a lane is proximate or near the location. Further, the anchor point may be used to identify a cross-section indicator, for example, in the form of x and y coordinates of the lane center, left lane edge, and right lane edge.

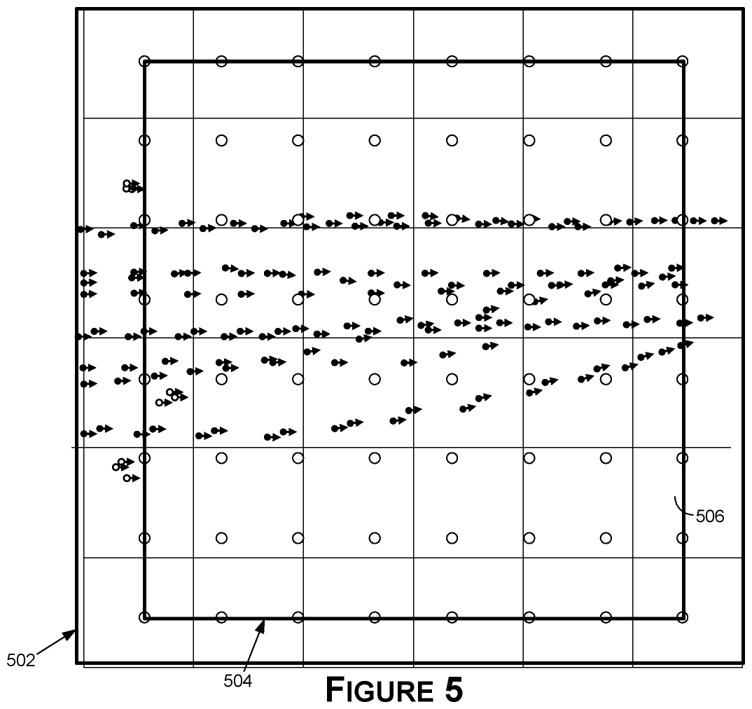

By way of example only, and with reference to FIG. 5, assume input data (e.g., cell representations) associated with a region 502 is input to the lane graph generation component 208. In such a case, an inference area 504, having a smaller size than the region 502, is created or identified. An anchor grid 506 may be positioned in accordance with the inference area 504. The anchor grid 506 may include any number of anchor boxes or any size of anchor boxes. In this example, the anchor grid 506 creates 64 anchor boxes. As such, queries may be generated or identified in association with various anchor boxes. In some cases, a query or set of queries may be generated for each anchor box. In other cases, a query or set of queries may be generated for a portion of anchor boxes (e.g., a randomly selected portion, a distributed selected portion, etc.). The anchor point or location associated with a query may be based on a particular location of the anchor box or the entirety of the location of the anchor box. As one example, a particular location or anchor point used in association with a query may be a center of an anchor box or a corner of an anchor box. In some cases, a query associated with a particular location (e.g., anchor box) may include multiple components to identify whether a lane exists in association with or near the particular location and, if so, cross-section indicators associated therewith (e.g. center location, left lane position, right lane position). In other cases, separate queries may be generated in association with a particular location. For example, one query may be used to identify whether a lane exists in association with or near the particular location, another query may be used to identify a center location of a cross-section, another query may be used to identify a left position of a cross-section, and another query may be used to identify a right position of a cross-section. In this regard, when four separate queries are generated for each of 64 anchor boxes, a total of 256 queries may be identified or used to query the input data to obtain desired output data, such as cross-section indicators.

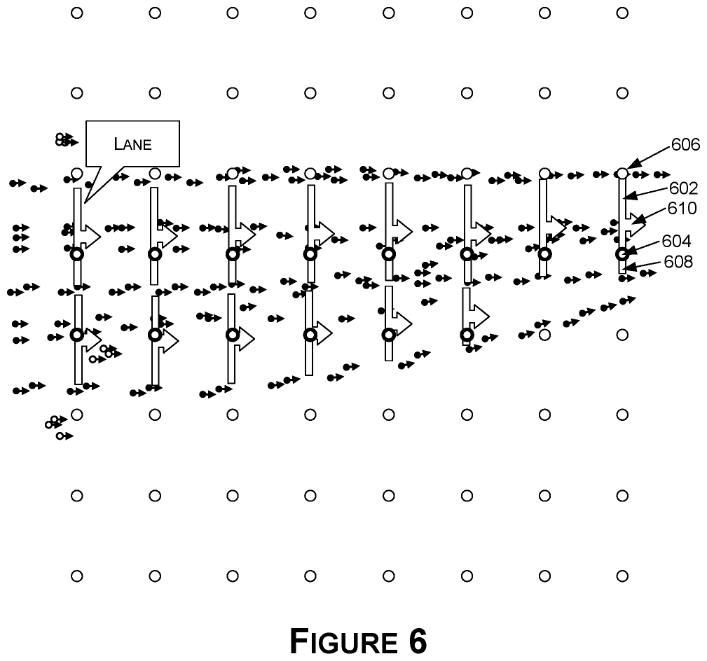

Turning to FIG. 6, FIG. 6 provides an example of cross-section indicators indicating cross-sections. The cross-sections illustrated in FIG. 6 are identified in association with a corresponding anchor point. In this example, queries associated with the other anchor points resulted in a determination that a nearby lane does not exist. As shown, a cross-section 602 may be identified in association with a query related to anchor point 604. In particular, in association with a query, or set of queries, related to anchor point 604, a lane is predicted to be positioned near the anchor point 604 and cross-section indicators indicating position of a cross-section is also identified. Such identified cross-section indicators may include a left position 606 indicating a left edge of a lane, a right position 608 indicating a right edge of a lane, and a center position 610 indicating a center of a lane. Similar cross-section indicators may be identified to indicate each cross-section. In some cases, the output associated with a particular anchor point may be a cross-section closest to the anchor point. In other cases, the output associated with a particular anchor point may include multiple cross-sections. Any number or position of cross-sections may be identified for a particular anchor point and is not intended to be limited to examples provided herein.

Returning to FIG. 2, the cross-section decoder 240 may generate and/or output other types of cross-section indicators and is not limited herein. As one example, in some cases, a type of a lane associated with a cross-section may be identified and output. For example, an indication of whether the lane is a traffic lane, a reversible lane, a bike lane, a high-occupancy vehicle (HOV) lane, etc. may be output.

A connection decoder 242 is generally configured to generate connection indicators. A connection indicator refers to data that indicates a lane connecting two locations. In embodiments, connection data may indicate a left edge of a lane and a right edge of the lane via polylines. In some embodiments, the connection decoder 242 may be configured to determine whether a lane is connected between two locations. If a lane is predicted to connect two locations, the connection decoder 242 may determine or generate connection data, such as a polylines or a geometry representing edges of a lane between the two locations. In determining or predicting whether a lane connection exists between two locations, a threshold value may be used (e.g., 0.5 during training and 0.8 during inference). For example, a confidence of a lane connection between two positions under 0.8 during inference may result in an invalid output or result, while a confidence of a lane connection between two positions above 0.8 during inference may result in a valid output or response. Upon meeting the threshold value for predicting a lane connection exists between two locations, the connection indicators may be identified and/or output. Such connection indicators may be provided in various formats or types of values. As one example, polylines representing the geometry of the connected lane may be generated and/or output as arrays or linked lists.

To predict whether a lane connects between two locations and/or generate connection indicators, the connection decoder 242 may use a cross-attention layer. As one example, a connection decoder 240 may include a cross-attention MLP(s). The MLP layer(s) may be used to convert the input into a desired output. In this regard, a neural network architecture may use a single layer of cross-attention to combine two different inputs (e.g., input sequences) to predict whether a lane connection exists between two points and/or generate connection indicators.

In operation, a cross-attention layer of a connection decoder 242 may process a set of queries indicating different pairs of locations. As such, the connection decoder 242 may take, as input, queries. As described, a query may be a vector representation indicating what the decoder is searching for in the input. In embodiments, the query may represent or include a pair of positions or locations, for example, in association with a cell, region, and/or environment scene (e.g., via anchor points). Such a position or location may be represented in any of a number of ways, such as, for example, an x-coordinate and a y-coordinate. A query obtained as input by the connection decoder 242 may be a learned query. For example, a learned query may be a random vector (e.g., of 32 values) that, during training, is optimized to become meaningful to the model.

As an example, the connection decoder 242 may receive a query in the form of, or including, a pair of anchor points, such as a source anchor point and a target anchor point. As described in connection with the cross-section decoder 240, the anchor points may be identified from an anchor grid. Alternatively, in some embodiments, the connection decoder 242 may receive a pair of queries with each query indicating an anchor point (e.g., one query indicates a source anchor point and another query indicates a target anchor point). In cases in which the connection decoder 242 identifies a connection between the two positions or locations, the connection decoder 242 may identify connection data indicating edges or geometry of the lane connected between the two positions. For instance, two polyline predictions representing a left edge of the connected lane and a right edge of the connected lane may be generated.

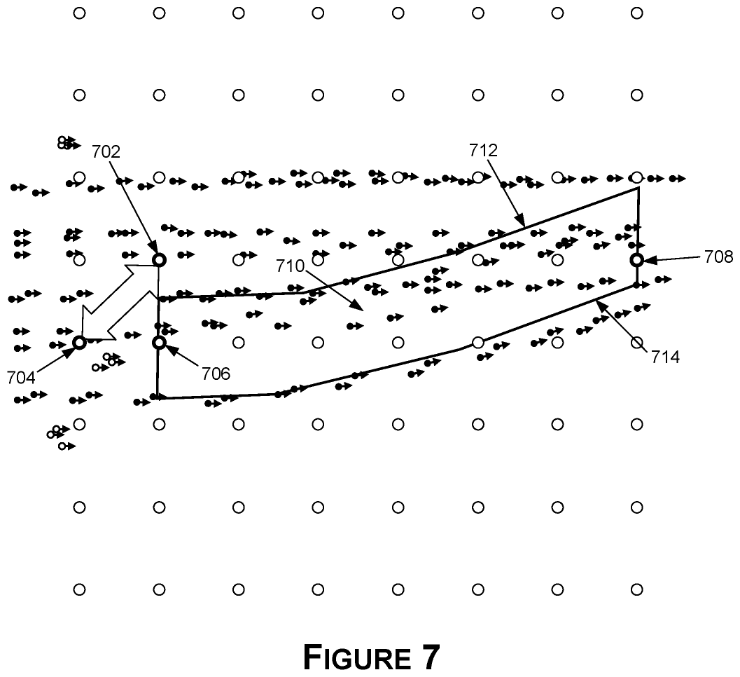

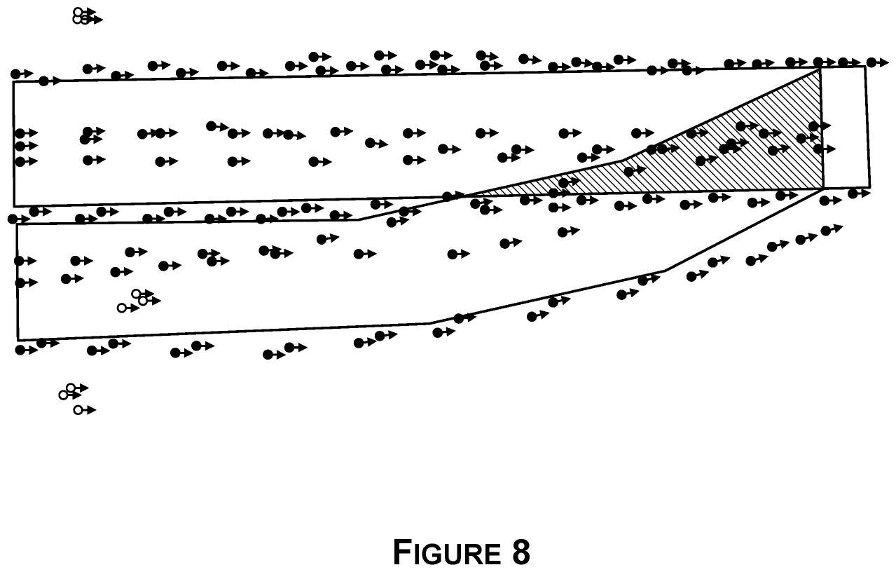

By way of example and with reference to FIG. 7, assume a first pair of anchor points 702 and 704 is used as a query(s). In such a case, a lane connecting the two anchor points 702 and 704 is not identified. On the other hand, assume a second pair of anchor points 706 and 708 is used as a query(s). In this example, a lane 710 connecting the two anchor points 706 and 708 is identified. As such, a polyline 712 representing a first edge of the lane and a polyline 714 representing a second edge of the lane are identified. FIG. 8 provides an illustration of connected lanes.

Locations (e.g., anchor points) for use in determining a lane connection therebetween may be selected in any of a number of ways. Pairs of locations may be randomly selected. For example, in some cases, random pairs of anchor points within a region or environment scene may be selected. In other cases, each combination of anchor pairs, for example, in a region, are selected.

In yet other cases, particular location pairs may be selected. By way of example only, location pairs may be identified as possibly being associated with a lane connection and, based on such a possibility, used as a query to identify whether a lane connection therebetween exists. For instance, in some implementations, post-processing in connection with the cross-section decoder 240 may occur and, based on analysis of the post-processing (e.g., performed via the lane graph generation manager 250), a pair of locations may be identified for determining whether a lane is connected therebetween. In this regard, post-processing performed via the lane graph generation manager 250 may be performed prior to the connection decoder 242 connecting a lane. In this manner, the connection decoder 242 may be used to connect lanes inferred via the cross-section decoder 240. By way of example only, assume cross-section decoder 240 generates a set of cross-sections, as identified using cross-section indicators of left lane edges and right lane edges. During post-processing, the identified cross-sections may be stitched or connected together to reflect a lane. In some cases, an end or termination of a lane may be detected (e.g., based on a proximity and/or orientation between cross-sections). In this way, a partial lane graph may be generated that includes unconnected lane portions. For instance, gaps in a lane may result in areas where lane cross-section prediction is ambiguous (e.g. intersections and lane split/merge areas). In such cases, the connection decoder 242 may be executed to determine whether a lane end is connected to another lane end (e.g., determine whether a path through the lane graph exists between the specified locations), indicating a lane connection. Stated differently, the connection decoder 242 may be used to identify connections between endpoints of lane portions, thereby completing a lane graph. For instance, a position or anchor point associated with a lane end may be analyzed along with a position or anchor point associated with another lane end to determine whether the two separately inferred lanes are connected. As such, the connection decoder 242 may facilitate combining or connecting two inferred lanes together, such as lanes inferred on opposing sides of an intersection (e.g., to connect through an intersection one inferred lane that ends at the entrance of the intersection and another inferred lane that ends at an exit of the intersection).

In some embodiments, the connection decoder 242 may take, as input, the previously generated latent representations (e.g., a region latent representation generated via encoder(s) 232). In other embodiments, new latent representations may be obtained as input. For example, new region latent representations may be generated and input to the connection decoder 242 for analysis in association with the queries of location pairs. In some cases, generating new latent representations may be used, for example, to identify connections when lane endpoints are in different regions used for identifying cross-sections.

The edge decoder 244 is generally configured to detect or determine edge indicators. An edge indicator generally refers to data indicating an edge of a lane. In embodiments, the edge decoder 244 may generate or predict polylines or a geometry representing the edges or boundaries of a lane. In this regard, the edge decoder 244 may output or provide identified or inferred lanes, for example, within a region. As such, a single edge decoder may output edge data used to construct a lane graph, such that a lane(s) is inferred using a single decoder (as opposed to using a combination of a cross-section decoder and connection decoder). In this way, in cases in which an edge decoder 244 is implemented, the cross-section decoder 240 and the connection decoder 242 may not be implemented. Further, various aspects of post-processing described below (e.g., stitch the cross-sections together) may be unnecessary.

In one embodiment, the edge decoder 244 may operate to generate edges of a lane(s) in the form of Bezier curves or other polyline parameterization. Polyline parameterization generally refers to a manner for representing a polyline that includes a series of straight segments by using parameters that define position and orientation of each segment. In one approach, the edge decoder 244 obtains a set of learnable queries that attend to a region latent representation generated by the encoder(s) 232. A cross-attention layer may be used such that the queries may identify most relevant keys and values associated with the encoded features. Such identified relevant keys and/or values may be aggregated and provided as output. Advantageously, a cross-attention layer enables focus on the most valuable portions in a region.

As described, the edge decoder 244 may provide, as output, Bezier curves or other polyline parameterization for queries. To do so, the edge decoder 244 may initially predict existence of a lane in association with a location. In cases that a lane is predicted in association with a particular location with a threshold value of confidence, edge indicators indicating Bezier curves or other polyline parameterization may be predicted. As one example, for a query, a pair of Bezier curves or Bezier control points representing a portion of a left lane edge and a portion of a right lane edge may be generated along with a scalar confidence value, thereby producing geometry of the lane. The identified Bezier control points identified in association with the left lane edge and right lane edge may define the edges of the lane (also referred to as a Bezier curve).

In one embodiment, such an edge decoder 244 may be trained using a Hungarian algorithm, which may identify an optimal assignment of predicted lanes to target lanes, such that the total cost of the assignment is minimized. The cost of assigning a predicted lane to a target lane may be a difference between shapes and/or positions thereof. In operation, upon identifying the optimal assignment (e.g., via Hungarian decoding), a loss for pairs of lanes may be determined and used to determine a total loss for a prediction, which may be used to train the edge decoder 244.

In another embodiment, the edge decoder 244 may operate to generate edges of a lane(s) using an autoregressive approach. To this end, the edge decoder 244 may initially identify a location that is likely a lane and, thereafter, autoregressivly determine other locations that are part of the lane. In this approach, the edge decoder 244 may autoregressively output keypoints along the centerlines of lanes by attending to the region latent representation (e.g., output by encoder(s) 232)). In embodiments, the keypoints are trained to lie along pre-defined vertical and horizontal gridlines in an inference area associated with a region. In this regard, the predicted keypoints may be intersections of lanes with a grid line(s) passing through the region. In addition to keypoints, the edge decoder 244 may predict offsets to the left lane edge and the right lane edge and geometry coefficients with respect to the previous keypoint.

The lane graph generation manager 250 is generally configured to generate lane graphs. A lane graph may refer to a type of map representation that describes the structure and topology of the lanes on a road. In embodiments, a lane graph may represent lane boundaries, lane centerlines, lane types (e.g., passing lane, carpool lane, turn lane, bike lane, bus lane, emergency lane, reversible lane, etc.), and/or lane attributes. As described herein, a lane graph may capture complex traffic scenarios, including lane changes, merges, splits, and intersection. An accurate lane graph is valuable for various automated driving tasks and map learning.

The lane graph generation manager 250 generally uses inferred lane data to generate lane graph(s) 215. To this end, lane data inferred via lane inference manager 230 may be used by the lane graph generation manager 250. As described herein, the resulting lane graph(s) 215 may be used to perform various functionality, such as various tasks for autonomous driving systems.

The lane graph generation manager 250 may generate a lane graph for any size area. As one example, a lane graph may be generated for the geographic scene, from which regions and cells are generated, as described herein. As described, lane data or inferred lanes are generated for various regions of a geographic scene. Accordingly, to generate a lane graph for the geographic scene, the lane data for the various regions may be aggregated together to generate the lane graph. In this way, the lane graph generation manager 250 may project inferred lanes or lane data for various regions (e.g., regions in which lanes are identified) onto the geographical scene.

The lane graph generation manager 250 implementation for generating a lane graph(s) may depend on the particular decoder(s) used to generate lane data and/or a type of lane data output via a decoder(s). In this way, different post-processing aspects may be performed in various implementations.

For instance, in embodiments in which only a cross-section decoder, such as cross-section decoder 240, is implemented, the lane graph generation manager 250 is generally configured to connect cross-sections to generate a lane graph. By way of example only, in one embodiment, the cross-sections identified via the cross-section decoder 240 may be projected back to a map view, such as a geographical map view, a region map view, etc. Thereafter, a set of candidate cross-sections may be identified for connecting to generate a lane graph. In one embodiment, cross-section candidates may be identified by binning a region into columns, such as N columns orthogonal to a driving or road direction. The columns may be of any size or number and is not intended to be limited herein. The columns may be divided or separated into bins, such as M number of bins. For a bin, a closest or nearest set of cross-sections are identified. For a bin having more than a threshold T number of identified cross-sections, a cross-section may be selected or generated as a representative cross-section. For instance, for a bin having more than a particular number of cross-sections, an average cross-section may be produced to generate a representative candidate cross-section for use in connecting cross-sections. Determining to aggregate cross-sections may also depend on other data, such as proximity of the cross-sections, left and/or right edges associated with the cross-section, angle associated with the cross-sections, etc. Aggregating cross-sections may be valuable in various examples, such as to represent overlapping cross-sections separately generated based on the regions being overlapping. In embodiments, tangent angles associated with candidate cross-sections may be identified or determined for use in identifying which cross-sections to connect, as described in more detail below.

In accordance with identifying candidate cross-sections for use in generating a lane graph, the lane graph generation manager 250 may connect one or more candidate cross-sections. Various analyses may be performed to determine which cross-section candidates to connect. In one embodiment, connecting cross-section candidates may be based on proximity and/or orientation between cross-sections. For example, cross-section candidates that are within a distance D from one another (e.g., a cross-section candidate under a distance D from a source cross-section) and maintain an angle difference less than A may be connected to generate a lane graph. In this regard, cross-sections in a proximity from one another and having a generally similar angles may be identified to be connected with one another. On the other hand, in cases in which a cross-section is more distant from another cross-section or has a varied orientation, the cross-sections may not be connected (e.g., an occurrence of a lane end, intersection, a lane split, a lane merge, etc.).

In some cases, small loops may result, for example, from a cross-section fork and merge. For instance, a split in the road may be predicted. In such cases, a loop detection algorithm may be used to remove a longer path in favor of the shorter path. For instance, the loop detection algorithm may identify loops (e.g., smaller than a threshold size) and connect over them such that a shorter path is selected.

In some cases, gaps in a lane may result, for example, based on a cross-section being beyond a threshold distance from another cross-section. In some implementations, to account for gaps such that the separate lanes may be properly connected, trajectories may be used to insert or complete missing connections between cross-sections. For instance, trajectories of ego vehicles may be identified and used to connect cross-sections such that separate lane portions are connected as a single lane. Using trajectories enables lane portions to be connected in instances in which observations may be missing (e.g., at intersections).

In embodiments in which a cross-section decoder (e.g., cross-section decoder 240) and a connection decoder (e.g., connection decoder 242) are implemented, the lane graph generation manager 250 may use the connection decoder 242 to connect cross-sections. In this regard, the connection decoder 242 may be used to identify connections between endpoints of lane portions. In some cases, the operations described above with respect to post-processing of the cross-sections may be performed and, rather than using trajectories to insert or complete missing connections between cross-sections, the connection decoder 242 may be used to complete the missing connections. In some cases in which the connection decoder 242 is used to complete missing connections, a smaller threshold may be used to initially identify whether cross-sections should be connected, such that only more confident connections are made between cross-connections prior to the connection decoder identifying additional cross-sections to connect.

As described above, the connection decoder 242 may analyze cross-sections identified as lane end points (e.g., not within a threshold distance and/or orientation to another cross-section) to determine connections therebetween. In cases in which a connection is identified or predicted between two cross-sections, or lane end points, the connection decoder 242 may output a geometry associated with the lane connection or the lane.

In embodiments in which an edge decoder is implemented, the lane graph generation manager 250 is generally configured to connect lanes inferred via the edge decoder, such as edge decoder 244. As described herein, the edge decoder 244 generally outputs a lane(s) geometry, or lane edges, in association with a region. In this regard, to generate a lane graph, the lane graph generation manager 250 may operate to project the edges, or indicators thereof, to a map view, such as a geometrical scene from which the regions and/or cells were constructed. In some embodiments, vertices may be sampled prior to projecting to a map view. For instance, vertices along a predict Bezier curve may be sampled and, thereafter, the sampled vertices may be projected to a global map view.

In some cases, as described herein, the edge data generated via an edge decoder may include Bezier curves and/or Bezier control points. In such cases, lane graph generation manager 250 may connect the projected curves and/or control points with one another. For example, such curves and/or control points may be stitched across neighboring regions using distance-based heuristics. Stitching lanes across regions may be determined based on the overlapping portions of the regions. For instance, assume a first region and a second region are adjacent to one another and have an overlapping portion. The overlapping portion may then be used to determine the manner in which to connect the lanes between the first and second region.

The lane graph generation manager 250 may use various other post-processing procedures to generate a lane graph(s). By way of example, and without implementation, various operations related to deduplicating lanes, smoothing lanes, merging lanes, removing bubbles, identifying speed limits, smoothing cluster centers, etc. may be implemented. The particular operations implemented via lane graph generation manager 250 may be selected in a desired manner that is suitable to generate a desired lane graph.

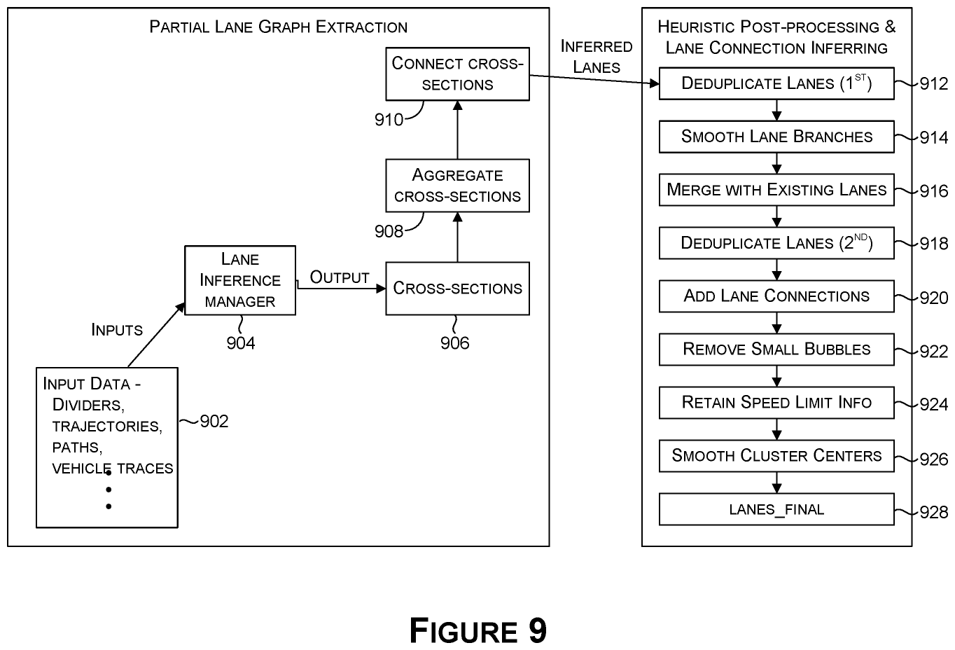

FIG. 9 is one example of a process flow for performing various post-processing operations in association with identifying lane cross-sections, for example, via a cross-section decoder (e.g., cross-section decoder 240 of FIG. 2). As shown in FIG. 9, based on input data 902, a lane inference manager 904, such as lane inference manager 230 of FIG. 2, may provide, as output, cross-sections 906. The cross-sections 906 may be represented in any of a number of ways including, for example, a center position, a left-edge position, and/or a right-edge position. At 908, the cross-sections may be aggregated. In this regard, the cross-sections associated with various regions may be projected, for example, to an environment scene or global map. Thereafter, at 910, cross-sections may be connected, as appropriate, to generate a lane graph that indicates lanes in the environment. In embodiments, such cross-section connections may be determined based on proximity and/or orientation of cross-sections relative to one another. As described herein, in some cases, lane ends may occur when cross-sections are not within proximity of one another and/or orientation associated with the cross-sections is not maintained. For example, lane ends may occur in accordance with opposing sides of an intersection. As such, further connection analysis may be performed to identify whether lane portions should be connected with one another to generate a single lane. In some embodiments, a connections decoder may be used to further analyze cross-sections for connections therebetween.

In other embodiments, a heuristic post-processing implementation may be used to connect appropriate cross-sections to generate the lane graph. Operations 912-928 provide one example of a heuristic post-processing implementation that may be used to connect cross-sections (e.g., associated with lane ends). Accordingly, the inferred lanes (e.g., the lanes generated based on connecting cross-sections, for example, in accordance with proximity and/or orientation) are provided for post-processing to generate the lane graph.

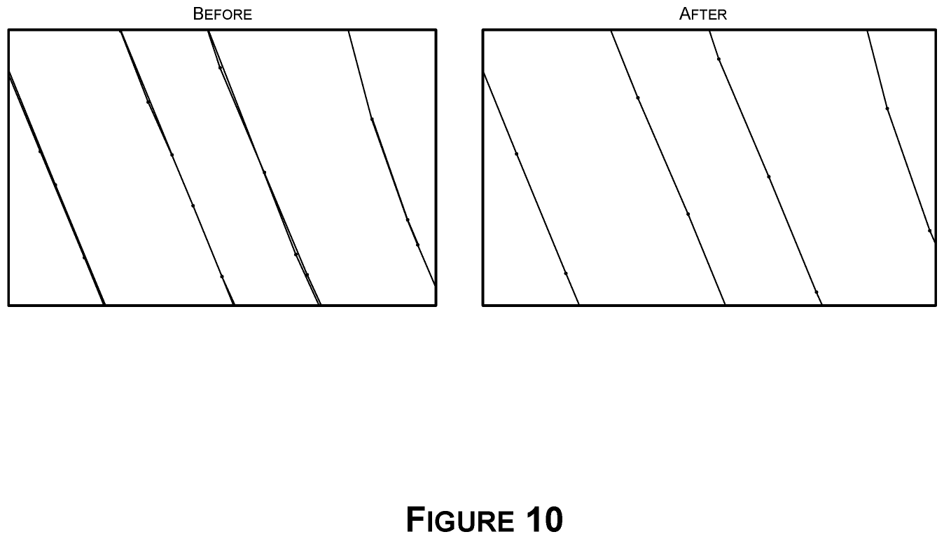

In FIG. 9, initially, at block 912, lanes are deduplicated, thereby removing duplicate lanes in the set of inferred lanes. This initial lane deduplication facilitates avoiding further duplication when adding lane connections and reduces opportunities for lane duplication in the final map. FIG. 10 provides an example of removing duplicate lanes.

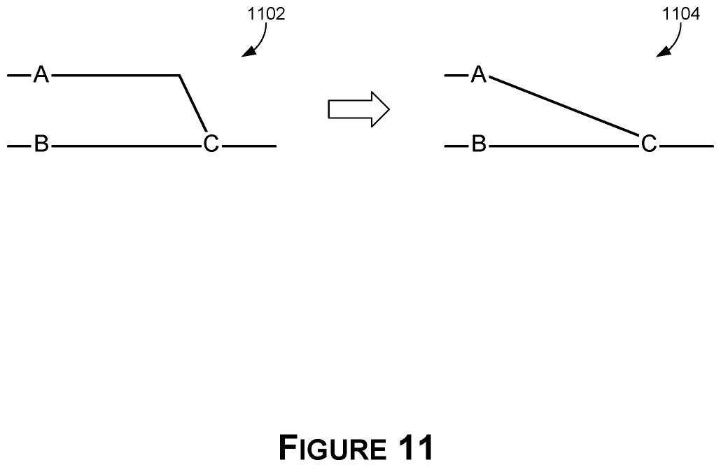

At block 914, lane connections are smoothed. For example, and, as shown in FIG. 11, an inferred lane connected between cross-sections may be provided with a sharp connection 1102 (e.g., in accordance with a lane split or merger). Upon smoothing, lane connection 1104 is provided with a more smooth transition between cross-sections.

At block 916, inferred lanes may be merged with existing lanes. In this regard, lane refusion with a previous map may be performed before adding a new lane connection in case a connection between inferred lanes and existing lanes in a previous map is needed.

At block 918, another iteration of lane deduplication is performed. This iteration of lane deduplication may be performed to remove duplicate lanes in merged lanes after refusion, that is, after the inferred lanes are merged with existing lanes.

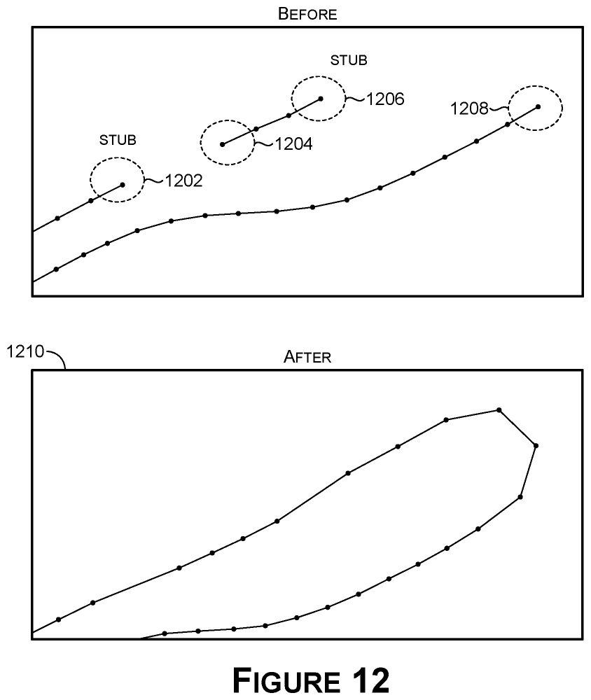

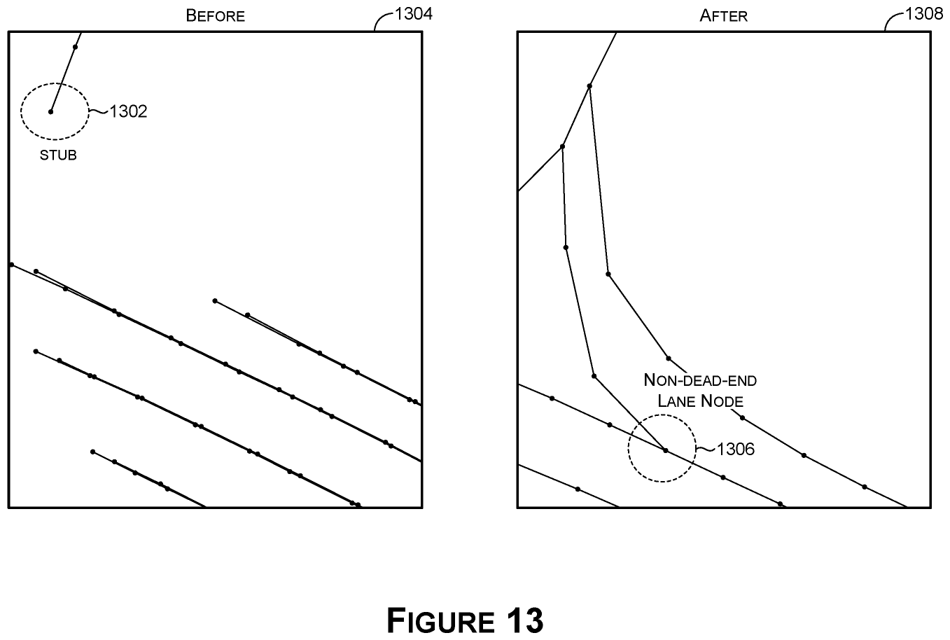

At block 920, lane connections are identified and generated. In this way, lane connections between various lane ends may be added to fill or complete missing lane connections between lanes (e.g., at turns or intersections). As described, in one embodiment, a determination to connect two lane portions may be based on whether there are trajectories passing between the lane portions (e.g., via a stub-to-stub connection or a stub-to-lane connection). As one example, a stub-to-stub connection connects an end lane node to another end lane node. For instance, FIG. 12 provides an example of a stub-to-stub connection. Stubs, or lane ends, 1202, 1204, 1206, and 1208 are identified. Based on analysis of trajectories, stubs 1202 and 1204 may be connected as well as stubs 1206 and 1208, as shown in image 1210. As another example, a stub-to-lane connection connects an end lane node to a non-end lane node. For instance, FIG. 13 provides an example of a stub-to-lane connection. As shown in FIG. 13, stub 1302 is initially unconnected to a lane, as shown in image 1304. Based on analysis of trajectories, stub 1302 is connected to non-end lane node 1306, as shown in image 1308.

Returning to FIG. 9, at block 922, bubbles are removed (e.g., small bubbles or bubbles below a threshold size). Removing bubbles facilitates removal of self-looping edges and overlapping lane edges. At block 924, speed limit information is identified and/or retained such that the speed limit may be included in a lane graph. At block 926, cluster centers are smoothed. In this way, lane cluster centers are adaptively smoothed per lateral acceleration. At block 928, the lanes are finalized to generate a lane graph. Lane finalization may be performed to ensure that connected newly inferred lanes and pristine segment lanes have matching endpoints. For example, due to resampling and reclustering of lane polylines, during initial lane inference, the inferred lane endpoints may not match up exactly with connected previous map lanes. As such, finalizing the lanes may ensure that the resulting lanes are connected and reduce gaps or overlaps therebetween.

Although various post-processing operations are provided in FIG. 9 in association with implementation of only a cross-section decoder, such as cross-section decoder 240, various operations may additionally or alternatively be used in association with other decoder implementations, such as implementation of a combination of the cross-section decoder and the connection decoder or implementation of an edge decoder. For example, deduplicating lanes and removing bubbles may occur with utilization of other decoders.

Turning to FIG. 14, FIG. 14 is a data flow diagram illustrating an example flow diagram 1400 for performing lane inference, in accordance with embodiments described herein. As shown in FIG. 14, a region 1402 of a geographic scene is identified. In some cases, to do so, a geographic scene, which includes region 1402, may be generated by projecting collected sensor data (e.g., measured 3D points) associated with multiple vehicles. For example, collected sensor data (e.g., the measured 3D points) may be projected to form a projection image representing any suitable view of the 3D environment (e.g., perspective, orthographic), having any number of channels (e.g., a single channel image, a multi-channel image or tensor) representing any characteristic(s) of the sensor data (e.g., projected position of a measured 3D point or polyline, one or more reflection characteristics, image data such as pixel color, etc.). The sensor data may include various types of data and may be obtained or collected from multiple vehicles to generate a more accurate lane inference and/or lane graph. In some implementations, sensor data associated with a particular geographical scene may be obtained (e.g., via a query for sensor data associated with a geographical location to obtain data from vehicles that have driven in that geographical location).

In accordance with generating a projection image corresponding with collected sensor data, the geographical scene may be divided into regions of a smaller size, such as region 1402, as compared to the geographical scene. In some cases, the regions may be overlapping regions of the projection image such that portions (e.g., edges) of regions overlap with portions (e.g., edges) of other regions. A region may be represented in any of a number of ways. As one example, region 1402 may be represented using points, or point representations, to represent sensor data associated with various polyline features and/or point features within the region 1402. In this regard, a region representation may include a set of point representations representing various points (e.g., each point or a subset of points) within the region. The points may include feature points and/or polyline points. Polyline points may be derived from the polylines in the region. For example, polylines of the region may be deconstructed into points (e.g., by sub-sampling the polylines at regular intervals). In this regard, collected polyline features may be resampled at fixed steps.

A point representation for a point may include various attributes associated with the point. For example, for each point, or a selected set of points, in a region, various attributes may be identified to store as a point representation. In this way, a point (e.g., in a point cloud associated with the region) may be represented in a manner that includes various attributes associated with the corresponding point. Various attributes that may be identified include, for example, a point category, a point position, a tangent, a distance, and left and/or right widths. In some embodiments, a point representation for a point is in the form of a vector embedding. In this way, a vector embedding is encoded or generated for each point or a set of points in a point cloud. The vector embedding may include a set of attributes for a point, such as, for example, a point category, a point position, a tangent, a distance, and left and/or right widths, as described above.

As shown in FIG. 14, the region 1402 is divided into a set of cells, such as cell 1404. As described, to facilitate a more efficient lane inference and/or lane generation, cell representations may be used to generate lane data. A region, such as region 1402, may be divided into any number of cells. In some embodiments, dilated cells that enlarge a portion associated with the grid are used. Using dilated cells provides collectively exhaustive and overlapping rectangular cells laid out on a grid.

In accordance with identifying or designating a cell(s), such as cell 1404, of region 1402, a cell representation(s) for the cell(s) may be generated for inputting into an encoder, such as cell encoder 1420. In embodiments, a cell may be represented in any number of ways. As one example, a cell may be represented using points, or point representations, to represent sensor data associated with various polyline features and/or point features identified via a sensor(s) in association with the cell. In this way, a cell representation includes points representations for a subset of points that correspond with the cell, or dilated cell. For instance, for a cell, a set of point representations (e.g., vector embeddings) associated with a set of points in the cell are aggregated or used to generate a cell representation. In some cases, a portion or subset of point representations may be used to generate a cell representation. For example, in some cases, point representations associated with a particular set of points may be used to generate a cell representation, thereby resulting in a cell representation of a fixed size (e.g. of a vector embedding representing the cell).

Such a portion or subset of point representation may be selected in any number of ways. As one example, a random sampler 1406 may be used to randomly sample or select a set of points per cell. For instance, a random sampler 1406 may be used to identify a particular number of points of a divider point type, a particular number of points of a trajectory point type, a particular number of points of a lane estimate point type, etc. In this example, a divider sampler 1408 may be used to identify sample points associated with dividers in a cell, a trajectory sampler 1410 may be used to identify sample points associated with trajectories in a cell, a lane sampler 1412 may be used to identify sample points associated with estimated lanes in a cell, and a trace sampler 1414 may be used to identify sample points associated with traces (e.g., motion trajectories of observed vehicles around an ego-vehicle) in a cell. In some cases, a particular number of sample points may be identified in association with each cell. For instance, continuing with the example in FIG. 14, 400 sample divider points, 100 sample trajectory points, 200 lane estimate points, and 300 trace points may be identified, resulting in a total of 1,000 points per cell. In this example with 36 cells, the total number of points identified for the region is 36,000.

As such, the resulting cells 1416 for each cell of region 1402 have a fixed or predetermined number, or maximum number, of points associated therewith. As described, the cell representation may be in a number of forms. In some cases, cell representation encoder 1418 generates a cell representation for each cell for input into a machine learning model, such as cell encoder 1420. In embodiments, a cell may be represented in any number of ways. As one example, a cell may be represented using points, or point representations, to represent sensor data associated with various polyline features and/or point features identified via a sensor(s) in association with the cell. In this way, a cell representation includes point representations for a subset of points that correspond with the cell, or dilated cell. For instance, for a cell, a set of point representations (e.g., vector embeddings) associated with a set of points in the cell are aggregated or used to generate a cell representation. In some cases, and as shown in FIG. 14, the cell representations 1416 may be appended with attributes or data in association with the point representations corresponding with the cell. For example, in some cases, a cell local coordinate may be determined for a point and appended as an attribute in the point representation. In this regard, the cell representation encoder 1418 may generate a cell local coordinate for a point from a global coordinate and/or region local coordinate associated with the point. As another example, in some cases, the cell representation encoder 1418 may determine a Fourier encoded position for a point and append the Fourier encoded position as an attribute in the point representation. In this way, the cell representation encoder 1418 may generate a Fourier encoded position for a point that generally represents a position of a point in a sequence or image using a set of sinusoidal functions.

As shown in FIG. 14, an example deep neural network in the form of a transformer is provided for processing the input and generating lane inferences. The example deep neural network includes encoders 1420 and 1440 and decoders 1450 and 1460. The encoders 1420 and 1440 are generally configured to generate a latent representation of a region (e.g., a portion of a geographic scene) using the set of cell representations associated with the region. At a high level, an encoder(s) in a transformer is generally a neural network component that processes an input (e.g., input sequence) and produces a latent representation(s) (e.g., a vector), that captures the meaning and structure of the input. As described herein, the encoder(s) is generally configured to generate a latent representation of a region (e.g., in the form of a vector), also referred to herein as a region latent representation, that captures the meaning and structure of the cell representations corresponding with the region. Generally, and at a high level, a latent representation refers to a representation produced for an input, that is, a simplified model of the input data that captures key features and may be used to reconstruct output. A latent representation may be in the form of a vector, in some examples.

In some embodiments, and as illustrated, the encoder component for a transformer is in the form of a hierarchical structure. In this regard, a cell encoder 1420 and a region encoder 1440 are used to generate a latent representation for the region. In particular, the cell encoder 1420 extract features and generate cell latent representations. The region encoder 1440 is used to relate the cell latent representations to one another and generate a region latent representation therefrom. In this regard, the cell latent representations generated via the cell encoder 1420 are provided as input to the region encoder 1440, which uses the cell latent representations to generate a region latent representation representing the region. As described herein, each encoder component, such as cell encoder 1420 and region encoder 1440, may include multiple encoder blocks or units, each of which performs self-attention or cross-attention on the input.

As shown in FIG. 14, cell representations are input into the cell encoder 1420. In some embodiments, the cell representations are input into the cell encoder 1420 in a sequential manner. In other embodiments, multiple cell representations, including all cell representations for a region, are input concurrently or near concurrently to the cell encoder 1420.

The cell encoder 1420 includes a cross-attention layer 1422 and a self-attention layer 1424. As shown in FIG. 14, the cell representations are input to the cross-attention layer 1422 of the cell encoder 1420. The cross-attention layer 1422 is generally configured to learn the relationship between different data (e.g., sequences of data). As such, the cross-attention layer 1422 may obtain two sequences of input (e.g., embeddings) as inputs. The input of the cell representations from the cell representation encoder 1418 may serve as one input in the form of keys and values, and the other input may be in the form of a latent(s) 1430 representing a query. The latent(s) 1430 may designate or indicate the output length of the cross-attention layer 1422, while the cell representations provide the information to be attended to. In embodiments, in accordance with obtaining the inputs, the cross-attention layer 1422 may compute the similarity between the latents 1430 and each key using a dot product and, thereafter, apply a softmax function to obtain the attention weights. The attention weights may then be multiplied with the corresponding values to produce the output. The output has the same dimension and length as the latent 1430.

In some cases, to generate the keys and values for the cross-attention layer 1422, a linear layer may be applied to transform the cell representation inputs. Generally, a linear layer may modify dimensionality of input data and learn correlation of data. In particular, a linear layer may learn a weight matrix and a bias vector that may be used to multiple and add to the input. The output of the linear layer may then be used to construct the keys and values for the cross-attention layer 1422. In some cases, the keys and values are matrices that represent similarity and relevance of the input cell representation embeddings to the latents 1430.

In embodiments, the latent(s) 1430 input to the cross-attention layer 1422 may be generated from learned latents 1426 representing queries. In some cases, the learned latents 1426 may initially be randomly generated. In accordance with training, the learned latents 1426 are learned to represent queries that facilitate extraction of valuable information such that different aspects may be learned from each cell. For example, one learned latent may focus on trajectory, while another learned latent may focus on dividers. In one embodiment, the learned latents 1426 may include eight vectors of 512 elements.

As shown, the learned latents 1426 may be processed using a tile and/or reshape function 1428. Tile and reshape may be implemented to modify the shape and size of the learned latents 1426. For example, tiling applied to the learned latents 1426 may result in repeating a vector or tensor along an axis(s). Reshaping applied to the learned latents 1426 may change the dimensions of a vector or tensor. Tiling and/or reshaping may be applied to align shapes for cross-attention. Based on the tile and/or reshaping, the latents 1430 are generated for inputting into the cross-attention layer 1422.

The output from the cross-attention layer 1422 is provided to the self-attention layer 1424. A self-attention layer 1424 enables capturing of dependencies and connections among input elements, thereby facilitating extraction of more meaningful information. The self-attention layer 1424 generates attention weights that indicate how much attention the model pays to various input elements. Such attention weights may then be multiplied with a value matrix to obtain a weighted sum of values, which may be output for the current input element. Latents 1432 (e.g., in the form of a matrix) may be output that represents the input with respect to each element. In some cases, self-attention layer 1424 may include multiple heads to attend to different aspects of input. Additionally or alternatively, the self-attention layer 1424 may perform operations in an iterative manner (e.g., four to size repeating loops).

In some cases, and as shown, the latents 1432 may be provided back to the cross-attention and self-attention layers to perform an iterative process. For example, the cross-attention and self-attention layers may be executed or repeated multiple times (e.g., two time) to identify a finalized latent for providing to a regional encoder 1440. As described, cell latents 1432 represent the various cells of the region 1402. In this example, a cell latent representation includes 8 vectors of 512 dimensions, but any number of vectors and dimensions may be used.

In embodiments, a cell position embedder 1434 may generate cell positions in association with each cell latent. A cell position generally refers to a position, location, or order indicating an ordering or positioning of the cells such that the cells may be related to one another. In this way, a cell position may be a unique position for the cell. As one example, a sequential ordering of cells may be used (e.g., numerical values). As another example, a coordinate associated with a cell in a region may be used to indicate cell position. The cell positions may be added to the latents such that cell latents 1436 include such cell position information. In one embodiment, the cell latents 1436 may include 544 output dimensions. For example, cell coordinates (X, Y) may be used with a Fourier embedding to generate a 16 dimensional embedding for each component, thereby resulting in a 32 dimensional vector. This 32 dimensional vector may be tiled and appended over the last dimension to the latent vector to produce the 544 output dimensions.

The cell latents 1436 are provided as input to the region encoder 1440. The region encoder 1440 may be used to relate the cell latent representations 1436 to one another and generate a latent representation for the region, also referred to as a region latent representation. For instance, the region encoder 1440 may design the information flow between various cells through self-attention. The self-attention layers may facilitate cell communication with neighbor cells as well as other cells. In some embodiments, increasing the dimensionality of latent vectors between the self-attention layers may improve performance that is achieved by using an MLP layer. In this example, the region encoder 1440 includes self-attention layer 1442, MLP expand layer 1444, and self-attention layer 1446. As shown, the self-attention layers 1442 and 1446 may be executed in iterative loops. The MLP expand layer 1444 is generally refers to a multilayer perceptron that is configured to expand dimensionalities.

The region latent representation generated via the region encoder 1440 is provided to one or more decoders to infer lanes or generate inference data. In FIG. 14, a cross-section decoder 1450 and a connection decoder 1460 are illustrated, but any combination or number of decoders described herein may be implemented. As described with reference to FIG. 2, the cross-section decoder 1450 is generally configured to generate cross-sections indicating points on an edge of a lane. As shown, the cross-section decoder 1450 may process a set of queries 1452 indicating different locations along with the region latent representation (e.g., output by an encoder(s)). As such, in addition to the cross-section decoder 240 taking as input region latent representations (e.g., from the encoder), queries may also be obtained as input. Queries 1452 may be learned queries that is learned from the data during the training process. For example, a learned query may be a random vector (e.g., of 32 values) that, during training, is optimized to become meaningful to the model. As described herein, the queries may be used to identify whether a cross-section exists near particular locations and, if so, cross-section indicators associated therewith. The connection decoder 1460 is generally configured to connect various cross-sections and/or lane portions to one another. For example, in one embodiment, lane portions may be identified in association with performing post-processing of cross-sections identified via cross-section decoder 1450. In such cases, positions associated with the lane portions may be used to identify whether the lane portions should be connected as a single lane and, if so, edges associated with such a single lane, or a channel therebetween. Upon inferring the lanes, via the cross-section decoder 1450 and/or the connection decoder 1460, the inferred lanes may be used to generate a lane graph.

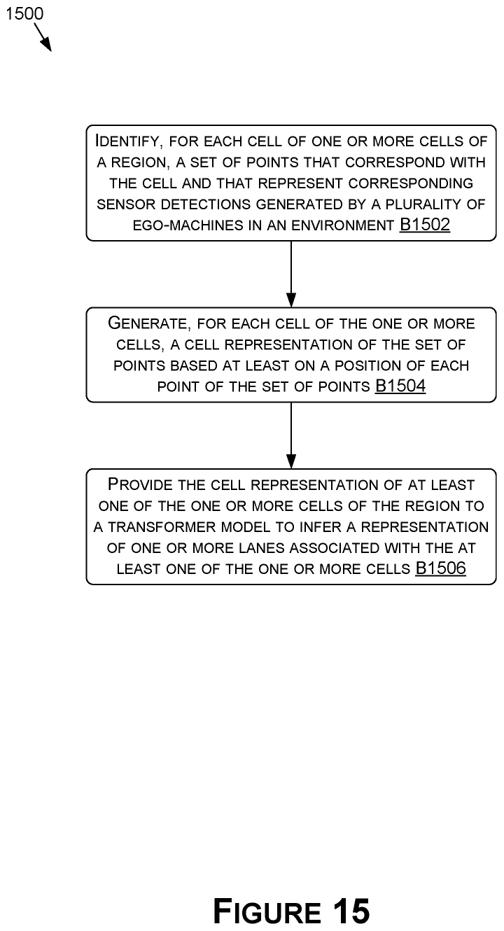

Now referring to FIGS. 15-18, each block of methods 1500, 1600, 1700, and 1800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 1500, 1600, 1700, and 1800 may be described, by way of example, with respect to the lane graph generation system of FIG. 1. However, these methods may additionally or alternatively be executed by any one system, or any combination of systems, including, but not limited to, those described herein.

FIG. 1500 is a flow diagram showing a method 1500 for generating input data for lane inference and/or lane graph generation, in accordance with some embodiments of the present disclosure. The method 1500, at block B1502, includes identifying, for each cell of one or more cells of a region, a set of points that correspond with the cell and that represent corresponding sensor detections generated by a plurality of ego-machines in an environment. For example, with respect to FIG. 2, the input generator 204 may segment an environment scene into a set of regions (e.g., overlapping regions). In some embodiments, the region may be a top-down representation of projected 3D locations of measured points. Each region may be segmented into a set of cells. In some cases, the cells overlap with one another. For each cell, a set of points within the cell boundaries may be identified. Such points may correspond with sensor detections generated by a plurality of ego-machines. In some cases, the points are point features detected by sensors.

Alternatively or additionally, the points may be derived or identified via polylines detected by sensors. The set of points may include each point within the boundaries of the cell. In other cases, the set of points may be a subset of points within the boundaries of the cell. For example, the set of points may be randomly sampled points (e.g., sampled in accordance with different types of points, such as dividers, trajectories, etc.).

The method 1500, at block B1504, includes generating, for each cell of the one or more cells, a cell representation of the set of points based at least on a position of each point of the set of points. For example, with respect to FIG. 2, the input generator 204 may generate a cell representation that includes point representations for each point of the set of points. Each point representation for a point may include a set of attribute values for various attributes, such as point type, position, tangent, distance, etc. In some cases, the point representation for a point includes or is augmented with a Fourier encoded position.

The method 1500, at block B1506, includes providing the cell representation of at least one of the one or more cells of the region to a transformer model to infer a representation of one or more lanes associated with the at least one of the one or more cells. For example, with respect to FIG. 2, the input generator 204 may provide the cell representation(s) to lane graph generation component 208. In particular, the cell representation(s) may be input to an encoder of the transformer model, which may use the cell representations to generate a latent representation of a region having the cell(s). The region latent representation may then be used to infer lanes or lane data.

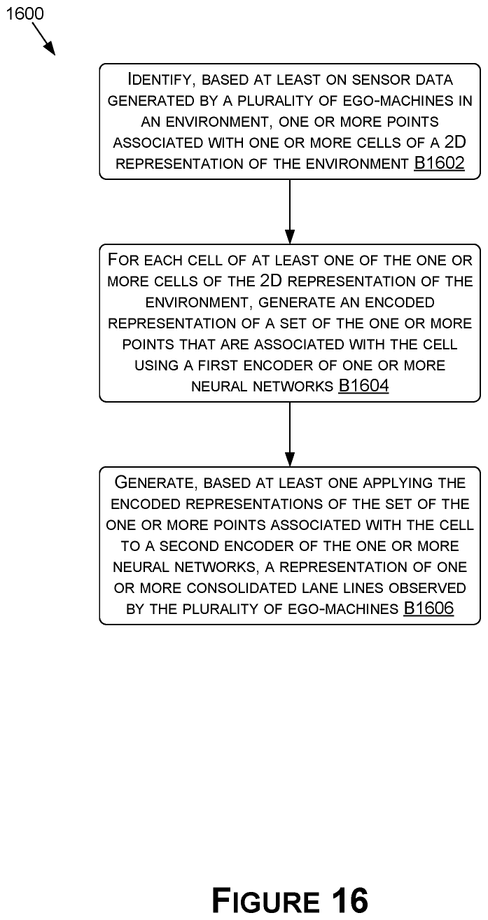

FIG. 16 is a flow diagram showing a method 1600 for generating one or lane inferences using one or more neural networks, in accordance with some embodiments of the present disclosure. The method 1600, at block B1602, includes identifying, based at least on sensor data generated by a plurality of ego-machines in an environment, one or more points associated with one or more cells of a two-dimensional representation of the environment. For example, with respect to FIG. 2, input generator 204 may identify a set of points associated with each cell within a region.

The method 1600, at block B1604, includes, for each cell of at least one of the one or more cells of the 2D representation of the environment, generating an encoded representation of a set of the one or more points that are associated with the cell using a first encoder of one or more neural networks. For example, with respect to FIG. 2, the cell encoder 236 may generate a cell latent representation that is an encoded representation of points associated with the cell. The cell encoder may include a cross-attention layer and a self-attention layer. In some cases, a cell position for each cell may be generated and included in the encoded representation.

The method 1600, at block B1606, includes generating, based at least on applying the encoded representations of the set of the one or more points associated with the cell to a second encoder of the one or more neural networks, a representation of one or more consolidated lane lines observed by the plurality of ego-machines. For example, with respect to FIG. 2, the region encoder 238 may take the encoded representations as input and generate a latent representation of the region, including consolidated lane lines observed by various ago-machines. In one embodiment, the region encoder 238 includes self-attention layers and a multilayer perceptron. The representation of the one or more consolidated lane lines may be provided as input to a decoder to infer lanes, which may be used to generate a lane graph.

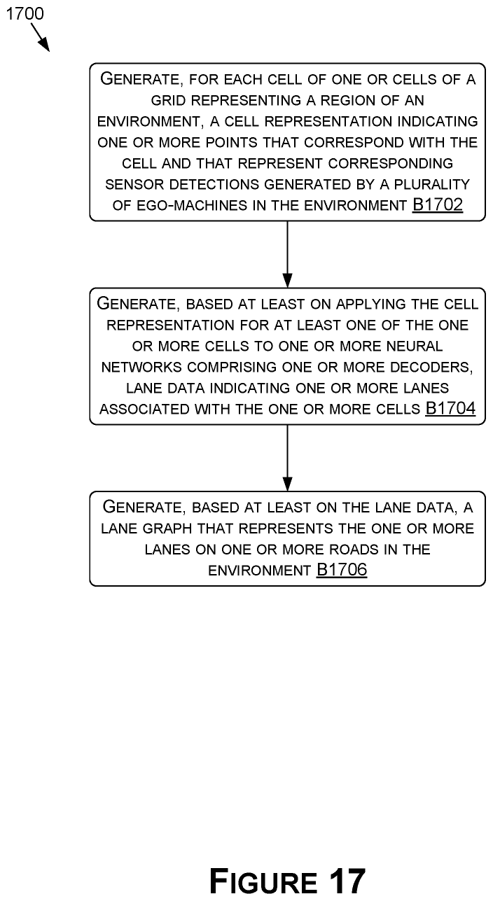

FIG. 17 is a flow diagram showing a method 1700 for generating lane graphs using one or more neural networks, in accordance with some embodiments of the present disclosure. The method 1700, at block B1702, includes generating, for each cell of one or cells of a grid representing a region of an environment, a cell representation indicating one or more points that correspond with the cell and that represent corresponding sensor detections generated by a plurality of ego-machines in the environment. For example, with respect to FIG. 2, a cell representation generator 224 may be used to generate a cell representation that represents points within a cell. The cell representation may be in the form of a vector and include point representations for points with the cell. Each point representation may include a set of attribute values associated with the corresponding point.

The method 1700, at block B1704, includes generating, based at least on applying the cell representation for at least one of the one or more cells to one or more neural networks comprising one or more decoders, lane data indicating one or more lanes associated with the one or more cells. For example, with respect to FIG. 2, one or more decoders 234 may be used to generate lane data. Lane data may be in various forms. As one example, lane data may be in the form of cross-section indicators. As another example, lane data may be in the form of connection indicators. As yet another example, lane data may be in the form of edge indicators indicating edges or geometry of a lane.

The method 1700, at block B1706, includes generating, based at least on the lane data, a lane graph that represents the one or more lanes on one or more roads in the environment. For example, with respect to FIG. 2, lane graph generation manager 250 may generate a lane graph representing roads. To do so, in some cases, the lane graph generation manager 250 may project lane data onto a map view. Further, in some cases, lane data may (e.g., cross-sections or lane geometries) may be stitched together, for instances, within a region, across regions, etc.

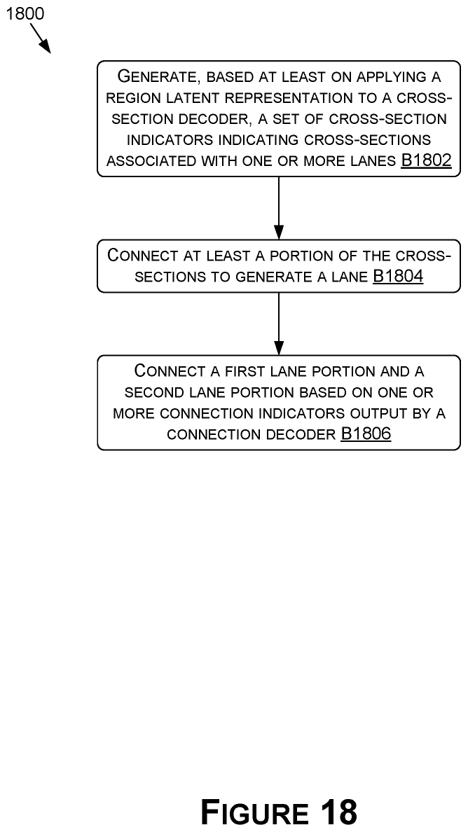

FIG. 18 is a flow diagram showing another method 1800 for generating lane graphs using one or more neural networks, in accordance with some embodiments of the present disclosure. The method 1800, at block B1802, includes generating, based at least on applying a region latent representation to a cross-section decoder, a set of cross-section indicators indicating cross-sections associated with one or more lanes. For example, with reference to FIG. 9, a cross-section decoder may generate a set of cross-sections indicators 906 based on an input region latent representation.

The method 1800, at block B1804, includes connecting at least a portion of the cross-sections to generate a lane. For example, with reference to FIG. 9, cross-sections connections are performed at 910. In embodiments, such cross-section connections may be determined based on proximity and/or orientation of cross-sections relative to one another. As described herein, in some cases, lane ends may occur when cross-sections are not within proximity of one another and/or orientation associated with the cross-sections is not maintained. For example, lane ends may occur in accordance with opposing sides of an intersection.

The method 1800, at block B1806, includes connecting a first lane portion and a second lane portion based on one or more connection indicators output by a connection decoder. For example, with reference to FIG. 9, lane connections 920 are identified and generated. In this way, lane connections between various lane ends may be added to fill or complete missing lane connections between lanes portions (e.g., at turns or intersections).

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 19A is an illustration of an example autonomous vehicle 1900, in accordance with some embodiments of the present disclosure. The autonomous vehicle 1900 (alternatively referred to herein as the “vehicle 1900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1900 may be capable of functionality in accordance with one or more of Level 3-Level 5 of the autonomous driving levels. The vehicle 1900 may be capable of functionality in accordance with one or more of Level 1-Level 5 of the autonomous driving levels. For example, the vehicle 1900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1900 or other machine, such as being fully autonomous, being highly autonomous, being conditionally autonomous, being partially autonomous, providing assistive autonomy, being semi-autonomous, being primarily autonomous, or other designation.

The vehicle 1900 may include components such as a chassis, a vehicle body, wheels (e.g., 2, 4, 6, 8, 18, etc.), tires, axles, and other components of a vehicle. The vehicle 1900 may include a propulsion system 1950, such as an internal combustion engine, hybrid electric power plant, an all-electric engine, and/or another propulsion system type. The propulsion system 1950 may be connected to a drive train of the vehicle 1900, which may include a transmission, to enable the propulsion of the vehicle 1900. The propulsion system 1950 may be controlled in response to receiving signals from the throttle/accelerator 1952.

A steering system 1954, which may include a steering wheel, may be used to steer the vehicle 1900 (e.g., along a desired path or route) when the propulsion system 1950 is operating (e.g., when the vehicle is in motion). The steering system 1954 may receive signals from a steering actuator 1956. The steering wheel may be optional for full automation (Level 5) functionality.

The brake sensor system 1946 may be used to operate the vehicle brakes in response to receiving signals from the brake actuators 1948 and/or brake sensors.

Controller(s) 1936, which may include one or more system on chips (SoCs) 1904 (FIG. 19C) and/or GPU(s), may provide signals (e.g., representative of commands) to one or more components and/or systems of the vehicle 1900. For example, the controller(s) may send signals to operate the vehicle brakes via one or more brake actuators 1948, to operate the steering system 1954 via one or more steering actuators 1956, to operate the propulsion system 1950 via one or more throttle/accelerators 1952. The controller(s) 1936 may include one or more onboard (e.g., integrated) computing devices (e.g., supercomputers) that process sensor signals, and output operation commands (e.g., signals representing commands) to enable autonomous driving and/or to assist a human driver in driving the vehicle 1900. The controller(s) 1936 may include a first controller 1936 for autonomous driving functions, a second controller 1936 for functional safety functions, a third controller 1936 for artificial intelligence functionality (e.g., computer vision), a fourth controller 1936 for infotainment functionality, a fifth controller 1936 for redundancy in emergency conditions, and/or other controllers. In some examples, a single controller 1936 may handle two or more of the above functionalities, two or more controllers 1936 may handle a single functionality, and/or any combination thereof.

The controller(s) 1936 may provide the signals for controlling one or more components and/or systems of the vehicle 1900 in response to sensor data received from one or more sensors (e.g., sensor inputs). The sensor data may be received from, for example and without limitation, global navigation satellite systems (“GNSS”) sensor(s) 1958 (e.g., Global Positioning System sensor(s)), RADAR sensor(s) 1960, ultrasonic sensor(s) 1962, LIDAR sensor(s) 1964, inertial measurement unit (IMU) sensor(s) 1966 (e.g., accelerometer(s), gyroscope(s), magnetic compass(es), magnetometer(s), etc.), microphone(s) 1996, stereo camera(s) 1968, wide-view camera(s) 1970 (e.g., fisheye cameras), infrared camera(s) 1972, surround camera(s) 1974 (e.g., 360 degree cameras), long-range and/or mid-range camera(s) 1998, speed sensor(s) 1944 (e.g., for measuring the speed of the vehicle 1900), vibration sensor(s) 1942, steering sensor(s) 1940, brake sensor(s) (e.g., as part of the brake sensor system 1946), and/or other sensor types.

One or more of the controller(s) 1936 may receive inputs (e.g., represented by input data) from an instrument cluster 1932 of the vehicle 1900 and provide outputs (e.g., represented by output data, display data, etc.) via a human-machine interface (HMI) display 1934, an audible annunciator, a loudspeaker, and/or via other components of the vehicle 1900. The outputs may include information such as vehicle velocity, speed, time, map data (e.g., the High Definition (“HD”) map 1922 of FIG. 19C), location data (e.g., the vehicle's 1900 location, such as on a map), direction, location of other vehicles (e.g., an occupancy grid), information about objects and status of objects as perceived by the controller(s) 1936, etc. For example, the HMI display 1934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1900 further includes a network interface 1922 which may use one or more wireless antenna(s) 1926 and/or modem(s) to communicate over one or more networks. For example, the network interface 1922 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 19B is an example of camera locations and fields of view for the example autonomous vehicle 1900 of FIG. 19A, in accordance with some embodiments of the present disclosure. The cameras and respective fields of view are one example embodiment and are not intended to be limiting. For example, additional and/or alternative cameras may be included and/or the cameras may be located at different locations on the vehicle 1900.

The camera types for the cameras may include, but are not limited to, digital cameras that may be adapted for use with the components and/or systems of the vehicle 1900. The camera(s) may operate at automotive safety integrity level (ASIL) B and/or at another ASIL. The camera types may be capable of any image capture rate, such as 60 frames per second (fps), 190 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1900 (e.g., front-facing cameras) may be used for surround view, to help identify forward facing paths and obstacles, as well aid in, with the help of one or more controllers 1936 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1970 that may be used to perceive objects coming into view from the periphery (e.g., pedestrians, crossing traffic or bicycles). Although only one wide-view camera is illustrated in FIG. 19B, there may be any number (including zero) of wide-view cameras 1970 on the vehicle 1900. In addition, any number of long-range camera(s) 1998 (e.g., a long-view stereo camera pair) may be used for depth-based object detection, especially for objects for which a neural network has not yet been trained. The long-range camera(s) 1998 may also be used for object detection and classification, as well as basic object tracking.

Any number of stereo cameras 1968 may also be included in a front-facing configuration. In at least one embodiment, one or more of stereo camera(s) 1968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1968 may be used in addition to, or alternatively from, those described herein.

Cameras with a field of view that include portions of the environment to the side of the vehicle 1900 (e.g., side-view cameras) may be used for surround view, providing information used to create and update the occupancy grid, as well as to generate side impact collision warnings. For example, surround camera(s) 1974 (e.g., four surround cameras 1974 as illustrated in FIG. 19B) may be positioned to on the vehicle 1900. The surround camera(s) 1974 may include wide-view camera(s) 1970, fisheye camera(s), 360 degree camera(s), and/or the like. Four example, four fisheye cameras may be positioned on the vehicle's front, rear, and sides. In an alternative arrangement, the vehicle may use three surround camera(s) 1974 (e.g., left, right, and rear), and may leverage one or more other camera(s) (e.g., a forward-facing camera) as a fourth surround view camera.

Cameras with a field of view that include portions of the environment to the rear of the vehicle 1900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1998, stereo camera(s) 1968), infrared camera(s) 1972, etc.), as described herein.

FIG. 19C is a block diagram of an example system architecture for the example autonomous vehicle 1900 of FIG. 19A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1900 in FIG. 19C are illustrated as being connected via bus 1902. The bus 1902 may include a Controller Area Network (CAN) data interface (alternatively referred to herein as a “CAN bus”). A CAN may be a network inside the vehicle 1900 used to aid in control of various features and functionality of the vehicle 1900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1902 is described herein as being a CAN bus, this is not intended to be limiting. For example, in addition to, or alternatively from, the CAN bus, FlexRay and/or Ethernet may be used. Additionally, although a single line is used to represent the bus 1902, this is not intended to be limiting. For example, there may be any number of busses 1902, which may include one or more CAN busses, one or more FlexRay busses, one or more Ethernet busses, and/or one or more other types of busses using a different protocol. In some examples, two or more busses 1902 may be used to perform different functions, and/or may be used for redundancy. For example, a first bus 1902 may be used for collision avoidance functionality and a second bus 1902 may be used for actuation control. In any example, each bus 1902 may communicate with any of the components of the vehicle 1900, and two or more busses 1902 may communicate with the same components. In some examples, each SoC 1904, each controller 1936, and/or each computer within the vehicle may have access to the same input data (e.g., inputs from sensors of the vehicle 1900), and may be connected to a common bus, such the CAN bus.

The vehicle 1900 may include one or more controller(s) 1936, such as those described herein with respect to FIG. 19A. The controller(s) 1936 may be used for a variety of functions. The controller(s) 1936 may be coupled to any of the various other components and systems of the vehicle 1900, and may be used for control of the vehicle 1900, artificial intelligence of the vehicle 1900, infotainment for the vehicle 1900, and/or the like.

The vehicle 1900 may include a system(s) on a chip (SoC) 1904. The SoC 1904 may include CPU(s) 1906, GPU(s) 1908, processor(s) 1910, cache(s) 1912, accelerator(s) 1914, data store(s) 1916, and/or other components and features not illustrated. The SoC(s) 1904 may be used to control the vehicle 1900 in a variety of platforms and systems. For example, the SoC(s) 1904 may be combined in a system (e.g., the system of the vehicle 1900) with an HD map 1922 which may obtain map refreshes and/or updates via a network interface 1922 from one or more servers (e.g., server(s) 1978 of FIG. 19D).

The CPU(s) 1906 may include a CPU cluster or CPU complex (alternatively referred to herein as a “CCPLEX”). The CPU(s) 1906 may include multiple cores and/or L2 caches. For example, in some embodiments, the CPU(s) 1906 may include eight cores in a coherent multi-processor configuration. In some embodiments, the CPU(s) 1906 may include four dual-core clusters where each cluster has a dedicated L2 cache (e.g., a 2 MB L2 cache). The CPU(s) 1906 (e.g., the CCPLEX) may be configured to support simultaneous cluster operation enabling any combination of the clusters of the CPU(s) 1906 to be active at any given time.

The CPU(s) 1906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1908 may include an integrated GPU (alternatively referred to herein as an “iGPU”). The GPU(s) 1908 may be programmable and may be efficient for parallel workloads. The GPU(s) 1908, in some examples, may use an enhanced tensor instruction set. The GPU(s) 1908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1908 may include at least eight streaming microprocessors. The GPU(s) 1908 may use compute application programming interface(s) (API(s)). In addition, the GPU(s) 1908 may use one or more parallel computing platforms and/or programming models (e.g., NVIDIA's CUDA).

The GPU(s) 1908 may be power-optimized for best performance in automotive and embedded use cases. For example, the GPU(s) 1908 may be fabricated on a Fin field-effect transistor (FinFET). However, this is not intended to be limiting and the GPU(s) 1908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1908 to access the CPU(s) 1906 page tables directly. In such examples, when the GPU(s) 1908 memory management unit (MMU) experiences a miss, an address translation request may be transmitted to the CPU(s) 1906. In response, the CPU(s) 1906 may look in its page tables for the virtual-to-physical mapping for the address and transmits the translation back to the GPU(s) 1908. As such, unified memory technology may allow a single unified virtual address space for memory of both the CPU(s) 1906 and the GPU(s) 1908, thereby simplifying the GPU(s) 1908 programming and porting of applications to the GPU(s) 1908.

In addition, the GPU(s) 1908 may include an access counter that may keep track of the frequency of access of the GPU(s) 1908 to memory of other processors. The access counter may help ensure that memory pages are moved to the physical memory of the processor that is accessing the pages most frequently.

The SoC(s) 1904 may include any number of cache(s) 1912, including those described herein. For example, the cache(s) 1912 may include an L3 cache that is available to both the CPU(s) 1906 and the GPU(s) 1908 (e.g., that is connected both the CPU(s) 1906 and the GPU(s) 1908). The cache(s) 1912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1904 may include an arithmetic logic unit(s) (ALU(s)) which may be leveraged in performing processing with respect to any of the variety of tasks or operations of the vehicle 1900—such as processing DNNs. In addition, the SoC(s) 1904 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1906 and/or GPU(s) 1908.

The SoC(s) 1904 may include one or more accelerators 1914 (e.g., hardware accelerators, software accelerators, or a combination thereof). For example, the SoC(s) 1904 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1908 and to off-load some of the tasks of the GPU(s) 1908 (e.g., to free up more cycles of the GPU(s) 1908 for performing other tasks). As an example, the accelerator(s) 1914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1908, and by using an inference accelerator, for example, a designer may target either the DLA(s) or the GPU(s) 1908 for any function. For example, the designer may focus processing of CNNs and floating point operations on the DLA(s) and leave other functions to the GPU(s) 1908 and/or other accelerator(s) 1914.

The accelerator(s) 1914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1914 (e.g., the hardware acceleration cluster) may include a computer vision network on-chip and SRAM, for providing a high-bandwidth, low latency SRAM for the accelerator(s) 1914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1966 output that correlates with the vehicle 1900 orientation, distance, 3D location estimates of the object obtained from the neural network and/or other sensors (e.g., LIDAR sensor(s) 1964 or RADAR sensor(s) 1960), among others.

The SoC(s) 1904 may include data store(s) 1916 (e.g., memory). The data store(s) 1916 may be on-chip memory of the SoC(s) 1904, which may store neural networks to be executed on the GPU and/or the DLA. In some examples, the data store(s) 1916 may be large enough in capacity to store multiple instances of neural networks for redundancy and safety. The data store(s) 1912 may comprise L2 or L3 cache(s) 1912. Reference to the data store(s) 1916 may include reference to the memory associated with the PVA, DLA, and/or other accelerator(s) 1914, as described herein.

The SoC(s) 1904 may include one or more processor(s) 1910 (e.g., embedded processors). The processor(s) 1910 may include a boot and power management processor that may be a dedicated processor and subsystem to handle boot power and management functions and related security enforcement. The boot and power management processor may be a part of the SoC(s) 1904 boot sequence and may provide runtime power management services. The boot power and management processor may provide clock and voltage programming, assistance in system low power state transitions, management of SoC(s) 1904 thermals and temperature sensors, and/or management of the SoC(s) 1904 power states. Each temperature sensor may be implemented as a ring-oscillator whose output frequency is proportional to temperature, and the SoC(s) 1904 may use the ring-oscillators to detect temperatures of the CPU(s) 1906, GPU(s) 1908, and/or accelerator(s) 1914. If temperatures are determined to exceed a threshold, the boot and power management processor may enter a temperature fault routine and put the SoC(s) 1904 into a lower power state and/or put the vehicle 1900 into a chauffeur to safe stop mode (e.g., bring the vehicle 1900 to a safe stop).

The processor(s) 1910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1910 may further include a real-time camera engine that may include a dedicated processor subsystem for handling real-time camera management.

The processor(s) 1910 may further include a high-dynamic range signal processor that may include an image signal processor that is a hardware engine that is part of the camera processing pipeline.

The processor(s) 1910 may include a video image compositor that may be a processing block (e.g., implemented on a microprocessor) that implements video post-processing functions needed by a video playback application to produce the final image for the player window. The video image compositor may perform lens distortion correction on wide-view camera(s) 1970, surround camera(s) 1974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1908 is not required to continuously render new surfaces. Even when the GPU(s) 1908 is powered on and active doing 3D rendering, the video image compositor may be used to offload the GPU(s) 1908 to improve performance and responsiveness.

The SoC(s) 1904 may further include a mobile industry processor interface (MIPI) camera serial interface for receiving video and input from cameras, a high-speed interface, and/or a video input block that may be used for camera and related pixel input functions. The SoC(s) 1904 may further include an input/output controller(s) that may be controlled by software and may be used for receiving I/O signals that are uncommitted to a specific role.

The SoC(s) 1904 may further include a broad range of peripheral interfaces to enable communication with peripherals, audio codecs, power management, and/or other devices. The SoC(s) 1904 may be used to process data from cameras (e.g., connected over Gigabit Multimedia Serial Link and Ethernet), sensors (e.g., LIDAR sensor(s) 1964, RADAR sensor(s) 1960, etc. that may be connected over Ethernet), data from bus 1902 (e.g., speed of vehicle 1900, steering wheel position, etc.), data from GNSS sensor(s) 1958 (e.g., connected over Ethernet or CAN bus). The SoC(s) 1904 may further include dedicated high-performance mass storage controllers that may include their own DMA engines, and that may be used to free the CPU(s) 1906 from routine data management tasks.

The SoC(s) 1904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1904 may be faster, more reliable, and even more energy-efficient and space-efficient than conventional systems. For example, the accelerator(s) 1914, when combined with the CPU(s) 1906, the GPU(s) 1908, and the data store(s) 1916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1908.

In some examples, a CNN for facial recognition and vehicle owner identification may use data from camera sensors to identify the presence of an authorized driver and/or owner of the vehicle 1900. The always on sensor processing engine may be used to unlock the vehicle when the owner approaches the driver door and turn on the lights, and, in security mode, to disable the vehicle when the owner leaves the vehicle. In this way, the SoC(s) 1904 provide for security against theft and/or carjacking.

In another example, a CNN for emergency vehicle detection and identification may use data from microphones 1996 to detect and identify emergency vehicle sirens. In contrast to conventional systems, that use general classifiers to detect sirens and manually extract features, the SoC(s) 1904 use the CNN for classifying environment and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1962, until the emergency vehicle(s) passes.

The vehicle may include a CPU(s) 1918 (e.g., discrete CPU(s), or dCPU(s)), that may be coupled to the SoC(s) 1904 via a high-speed interconnect (e.g., PCIe). The CPU(s) 1918 may include an X86 processor, for example. The CPU(s) 1918 may be used to perform any of a variety of functions, including arbitrating potentially inconsistent results between ADAS sensors and the SoC(s) 1904, and/or monitoring the status and health of the controller(s) 1936 and/or infotainment SoC 1930, for example.

The vehicle 1900 may include a GPU(s) 1920 (e.g., discrete GPU(s), or dGPU(s)), that may be coupled to the SoC(s) 1904 via a high-speed interconnect (e.g., NVIDIA's NVLINK). The GPU(s) 1920 may provide additional artificial intelligence functionality, such as by executing redundant and/or different neural networks, and may be used to train and/or update neural networks based on input (e.g., sensor data) from sensors of the vehicle 1900.

The vehicle 1900 may further include the network interface 1922 which may include one or more wireless antennas 1926 (e.g., one or more wireless antennas for different communication protocols, such as a cellular antenna, a Bluetooth antenna, etc.). The network interface 1922 may be used to enable wireless connectivity over the Internet with the cloud (e.g., with the server(s) 1978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1900 information about vehicles in proximity to the vehicle 1900 (e.g., vehicles in front of, on the side of, and/or behind the vehicle 1900). This functionality may be part of a cooperative adaptive cruise control functionality of the vehicle 1900.

The network interface 1922 may include a SoC that provides modulation and demodulation functionality and enables the controller(s) 1936 to communicate over wireless networks. The network interface 1922 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1900 may further include data store(s) 1928 which may include off-chip (e.g., off the SoC(s) 1904) storage. The data store(s) 1928 may include one or more storage elements including RAM, SRAM, DRAM, VRAM, Flash, hard disks, and/or other components and/or devices that may store at least one bit of data.

The vehicle 1900 may further include GNSS sensor(s) 1958. The GNSS sensor(s) 1958 (e.g., GPS, assisted GPS sensors, differential GPS (DGPS) sensors, etc.), to assist in mapping, perception, occupancy grid generation, and/or path planning functions. Any number of GNSS sensor(s) 1958 may be used, including, for example and without limitation, a GPS using a USB connector with an Ethernet to Serial (RS-232) bridge.

The vehicle 1900 may further include RADAR sensor(s) 1960. The RADAR sensor(s) 1960 may be used by the vehicle 1900 for long-range vehicle detection, even in darkness and/or severe weather conditions. RADAR functional safety levels may be ASIL B. The RADAR sensor(s) 1960 may use the CAN and/or the bus 1902 (e.g., to transmit data generated by the RADAR sensor(s) 1960) for control and to access object tracking data, with access to Ethernet to access raw data in some examples. A wide variety of RADAR sensor types may be used. For example, and without limitation, the RADAR sensor(s) 1960 may be suitable for front, rear, and side RADAR use. In some example, Pulse Doppler RADAR sensor(s) are used.

The RADAR sensor(s) 1960 may include different configurations, such as long range with narrow field of view, short range with wide field of view, short range side coverage, etc. In some examples, long-range RADAR may be used for adaptive cruise control functionality.

The long-range RADAR systems may provide a broad field of view realized by two or more independent scans, such as within a 250 m range. The RADAR sensor(s) 1960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1900 surroundings at higher speeds with minimal interference from traffic in adjacent lanes. The other two antennae may expand the field of view, making it possible to quickly detect vehicles entering or leaving the vehicle's 1900 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1900 may further include ultrasonic sensor(s) 1962. The ultrasonic sensor(s) 1962, which may be positioned at the front, back, and/or the sides of the vehicle 1900, may be used for park assist and/or to create and update an occupancy grid. A wide variety of ultrasonic sensor(s) 1962 may be used, and different ultrasonic sensor(s) 1962 may be used for different ranges of detection (e.g., 2.5 m, 4 m). The ultrasonic sensor(s) 1962 may operate at functional safety levels of ASIL B.

The vehicle 1900 may include LIDAR sensor(s) 1964. The LIDAR sensor(s) 1964 may be used for object and pedestrian detection, emergency braking, collision avoidance, and/or other functions. The LIDAR sensor(s) 1964 may be functional safety level ASIL B. In some examples, the vehicle 1900 may include multiple LIDAR sensors 1964 (e.g., two, four, six, etc.) that may use Ethernet (e.g., to provide data to a Gigabit Ethernet switch).

In some examples, the LIDAR sensor(s) 1964 may be capable of providing a list of objects and their distances for a 360-degree field of view. Commercially available LIDAR sensor(s) 1964 may have an advertised range of approximately 1200 m, with an accuracy of 2 cm-3 cm, and with support for a 1200 Mbps Ethernet connection, for example. In some examples, one or more non-protruding LIDAR sensors 1964 may be used. In such examples, the LIDAR sensor(s) 1964 may be implemented as a small device that may be embedded into the front, rear, sides, and/or corners of the vehicle 1900. The LIDAR sensor(s) 1964, in such examples, may provide up to a 120-degree horizontal and 35-degree vertical field-of-view, with a 200m range even for low-reflectivity objects. Front-mounted LIDAR sensor(s) 1964 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1900. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1964 may be less susceptible to motion blur, vibration, and/or shock.

The vehicle may further include IMU sensor(s) 1966. The IMU sensor(s) 1966 may be located at a center of the rear axle of the vehicle 1900, in some examples. The IMU sensor(s) 1966 may include, for example and without limitation, an accelerometer(s), a magnetometer(s), a gyroscope(s), a magnetic compass(es), and/or other sensor types. In some examples, such as in six-axis applications, the IMU sensor(s) 1966 may include accelerometers and gyroscopes, while in nine-axis applications, the IMU sensor(s) 1966 may include accelerometers, gyroscopes, and magnetometers.

In some embodiments, the IMU sensor(s) 1966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1966 may enable the vehicle 1900 to estimate heading without requiring input from a magnetic sensor by directly observing and correlating the changes in velocity from GPS to the IMU sensor(s) 1966. In some examples, the IMU sensor(s) 1966 and the GNSS sensor(s) 1958 may be combined in a single integrated unit.

The vehicle may include microphone(s) 1996 placed in and/or around the vehicle 1900. The microphone(s) 1996 may be used for emergency vehicle detection and identification, among other things.

The vehicle may further include any number of camera types, including stereo camera(s) 1968, wide-view camera(s) 1970, infrared camera(s) 1972, surround camera(s) 1974, long-range and/or mid-range camera(s) 1998, and/or other camera types. The cameras may be used to capture image data around an entire periphery of the vehicle 1900. The types of cameras used depends on the embodiments and requirements for the vehicle 1900, and any combination of camera types may be used to provide the necessary coverage around the vehicle 1900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 19A and FIG. 19B.

The vehicle 1900 may further include vibration sensor(s) 1942. The vibration sensor(s) 1942 may measure vibrations of components of the vehicle, such as the axle(s). For example, changes in vibrations may indicate a change in road surfaces. In another example, when two or more vibration sensors 1942 are used, the differences between the vibrations may be used to determine friction or slippage of the road surface (e.g., when the difference in vibration is between a power-driven axle and a freely rotating axle).

The vehicle 1900 may include an ADAS system 1938. The ADAS system 1938 may include a SoC, in some examples. The ADAS system 1938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1960, LIDAR sensor(s) 1964, and/or a camera(s). The ACC systems may include longitudinal ACC and/or lateral ACC. Longitudinal ACC monitors and controls the distance to the vehicle immediately ahead of the vehicle 1900 and automatically adjust the vehicle speed to maintain a safe distance from vehicles ahead. Lateral ACC performs distance keeping, and advises the vehicle 1900 to change lanes when necessary. Lateral ACC is related to other ADAS applications such as LCA and CWS.

CACC uses information from other vehicles that may be received via the network interface 1922 and/or the wireless antenna(s) 1926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1900), while the 12V communication concept provides information about traffic further ahead. CACC systems may include either or both I2V and V2V information sources. Given the information of the vehicles ahead of the vehicle 1900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1900 if the vehicle 1900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1900 is backing up. Some RCTW systems include AEB to ensure that the vehicle brakes are applied to avoid a crash. RCTW systems may use one or more rear-facing RADAR sensor(s) 1960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1900, the vehicle 1900 itself must, in the case of conflicting results, decide whether to heed the result from a primary computer or a secondary computer (e.g., a first controller 1936 or a second controller 1936). For example, in some embodiments, the ADAS system 1938 may be a backup and/or secondary computer for providing perception information to a backup computer rationality module. The backup computer rationality monitor may run a redundant diverse software on hardware components to detect faults in perception and dynamic driving tasks. Outputs from the ADAS system 1938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1904.

In other examples, ADAS system 1938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1938 may be fed into the primary computer's perception block and/or the primary computer's dynamic driving task block. For example, if the ADAS system 1938 indicates a forward crash warning due to an object immediately ahead, the perception block may use this information when identifying objects. In other examples, the secondary computer may have its own neural network which is trained and thus reduces the risk of false positives, as described herein.

The vehicle 1900 may further include the infotainment SoC 1930 (e.g., an in-vehicle infotainment system (IVI)). Although illustrated and described as a SoC, the infotainment system may not be a SoC, and may include two or more discrete components. The infotainment SoC 1930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1900. For example, the infotainment SoC 1930 may radios, disk players, navigation systems, video players, USB and Bluetooth connectivity, carputers, in-car entertainment, Wi-Fi, steering wheel audio controls, hands free voice control, a heads-up display (HUD), an HMI display 1934, a telematics device, a control panel (e.g., for controlling and/or interacting with various components, features, and/or systems), and/or other components. The infotainment SoC 1930 may further be used to provide information (e.g., visual and/or audible) to a user(s) of the vehicle, such as information from the ADAS system 1938, autonomous driving information such as planned vehicle maneuvers, trajectories, surrounding environment information (e.g., intersection information, vehicle information, road information, etc.), and/or other information.

The infotainment SoC 1930 may include GPU functionality. The infotainment SoC 1930 may communicate over the bus 1902 (e.g., CAN bus, Ethernet, etc.) with other devices, systems, and/or components of the vehicle 1900. In some examples, the infotainment SoC 1930 may be coupled to a supervisory MCU such that the GPU of the infotainment system may perform some self-driving functions in the event that the primary controller(s) 1936 (e.g., the primary and/or backup computers of the vehicle 1900) fail. In such an example, the infotainment SoC 1930 may put the vehicle 1900 into a chauffeur to safe stop mode, as described herein.

The vehicle 1900 may further include an instrument cluster 1932 (e.g., a digital dash, an electronic instrument cluster, a digital instrument panel, etc.). The instrument cluster 1932 may include a controller and/or supercomputer (e.g., a discrete controller or supercomputer). The instrument cluster 1932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1930 and the instrument cluster 1932. In other words, the instrument cluster 1932 may be included as part of the infotainment SoC 1930, or vice versa.

FIG. 19D is a system diagram for communication between cloud-based server(s) and the example autonomous vehicle 1900 of FIG. 19A, in accordance with some embodiments of the present disclosure. The system 1976 may include server(s) 1978, network(s) 1990, and vehicles, including the vehicle 1900. The server(s) 1978 may include a plurality of GPUs 1984 (A)-1984 (H) (collectively referred to herein as GPUs 1984), PCIe switches 1982 (A)-1982 (H) (collectively referred to herein as PCIe switches 1982), and/or CPUs 1980 (A)-1980 (B) (collectively referred to herein as CPUs 1980). The GPUs 1984, the CPUs 1980, and the PCIe switches may be interconnected with high-speed interconnects such as, for example and without limitation, NVLink interfaces 1988 developed by NVIDIA and/or PCIe connections 1986. In some examples, the GPUs 1984 are connected via NVLink and/or NVSwitch SoC and the GPUs 1984 and the PCIe switches 1982 are connected via PCIe interconnects. Although eight GPUs 1984, two CPUs 1980, and two PCIe switches are illustrated, this is not intended to be limiting. Depending on the embodiment, each of the server(s) 1978 may include any number of GPUs 1984, CPUs 1980, and/or PCIe switches. For example, the server(s) 1978 may each include eight, sixteen, thirty-two, and/or more GPUs 1984.

The server(s) 1978 may receive, over the network(s) 1990 and from the vehicles, image data representative of images showing unexpected or changed road conditions, such as recently commenced road-work. The server(s) 1978 may transmit, over the network(s) 1990 and to the vehicles, neural networks 1992, updated neural networks 1992, and/or map information 1994, including information regarding traffic and road conditions. The updates to the map information 1994 may include updates for the HD map 1922, such as information regarding construction sites, potholes, detours, flooding, and/or other obstructions. In some examples, the neural networks 1992, the updated neural networks 1992, and/or the map information 1994 may have resulted from new training and/or experiences represented in data received from any number of vehicles in the environment, and/or based on training performed at a datacenter (e.g., using the server(s) 1978 and/or other servers).

The server(s) 1978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1990, and/or the machine learning models may be used by the server(s) 1978 to remotely monitor the vehicles.

In some examples, the server(s) 1978 may receive data from the vehicles and apply the data to up-to-date real-time neural networks for real-time intelligent inferencing. The server(s) 1978 may include deep-learning supercomputers and/or dedicated AI computers powered by GPU(s) 1984, such as a DGX and DGX Station machines developed by NVIDIA. However, in some examples, the server(s) 1978 may include deep learning infrastructure that use only CPU-powered datacenters.

The deep-learning infrastructure of the server(s) 1978 may be capable of fast, real-time inferencing, and may use that capability to evaluate and verify the health of the processors, software, and/or associated hardware in the vehicle 1900. For example, the deep-learning infrastructure may receive periodic updates from the vehicle 1900, such as a sequence of images and/or objects that the vehicle 1900 has located in that sequence of images (e.g., via computer vision and/or other machine learning object classification techniques). The deep-learning infrastructure may run its own neural network to identify the objects and compare them with the objects identified by the vehicle 1900 and, if the results do not match and the infrastructure concludes that the AI in the vehicle 1900 is malfunctioning, the server(s) 1978 may transmit a signal to the vehicle 1900 instructing a fail-safe computer of the vehicle 1900 to assume control, notify the passengers, and complete a safe parking maneuver.

For inferencing, the server(s) 1978 may include the GPU(s) 1984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 20 is a block diagram of an example computing device(s) 2000 suitable for use in implementing some embodiments of the present disclosure. Computing device 2000 may include an interconnect system 2002 that directly or indirectly couples the following devices: memory 2004, one or more central processing units (CPUs) 2006, one or more graphics processing units (GPUs) 2008, a communication interface 2010, input/output (I/O) ports 2012, input/output components 2014, a power supply 2016, one or more presentation components 2018 (e.g., display(s)), and one or more logic units 2020. In at least one embodiment, the computing device(s) 2000 may comprise one or more virtual machines (VMs), and/or any of the components thereof may comprise virtual components (e.g., virtual hardware components). For non-limiting examples, one or more of the GPUs 2008 may comprise one or more vGPUs, one or more of the CPUs 2006 may comprise one or more vCPUs, and/or one or more of the logic units 2020 may comprise one or more virtual logic units. As such, a computing device(s) 2000 may include discrete components (e.g., a full GPU dedicated to the computing device 2000), virtual components (e.g., a portion of a GPU dedicated to the computing device 2000), or a combination thereof.

Although the various blocks of FIG. 20 are shown as connected via the interconnect system 2002 with lines, this is not intended to be limiting and is for clarity only. For example, in some embodiments, a presentation component 2018, such as a display device, may be considered an I/O component 2014 (e.g., if the display is a touch screen). As another example, the CPUs 2006 and/or GPUs 2008 may include memory (e.g., the memory 2004 may be representative of a storage device in addition to the memory of the GPUs 2008, the CPUs 2006, and/or other components). In other words, the computing device of FIG. 20 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 20.

The interconnect system 2002 may represent one or more links or busses, such as an address bus, a data bus, a control bus, or a combination thereof. The interconnect system 2002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 2006 may be directly connected to the memory 2004. Further, the CPU 2006 may be directly connected to the GPU 2008. Where there is direct, or point-to-point connection between components, the interconnect system 2002 may include a PCIe link to carry out the connection. In these examples, a PCI bus need not be included in the computing device 2000.

The memory 2004 may include any of a variety of computer-readable media. The computer-readable media may be any available media that may be accessed by the computing device 2000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 2004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 2000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 2006 may be configured to execute at least some of the computer-readable instructions to control one or more components of the computing device 2000 to perform one or more of the methods and/or processes described herein. The CPU(s) 2006 may each include one or more cores (e.g., one, two, four, eight, twenty-eight, seventy-two, etc.) that are capable of handling a multitude of software threads simultaneously. The CPU(s) 2006 may include any type of processor, and may include different types of processors depending on the type of computing device 2000 implemented (e.g., processors with fewer cores for mobile devices and processors with more cores for servers). For example, depending on the type of computing device 2000, the processor may be an Advanced RISC Machines (ARM) processor implemented using Reduced Instruction Set Computing (RISC) or an x86 processor implemented using Complex Instruction Set Computing (CISC). The computing device 2000 may include one or more CPUs 2006 in addition to one or more microprocessors or supplementary co-processors, such as math co-processors.

In addition to or alternatively from the CPU(s) 2006, the GPU(s) 2008 may be configured to execute at least some of the computer-readable instructions to control one or more components of the computing device 2000 to perform one or more of the methods and/or processes described herein. One or more of the GPU(s) 2008 may be an integrated GPU (e.g., with one or more of the CPU(s) 2006 and/or one or more of the GPU(s) 2008 may be a discrete GPU. In embodiments, one or more of the GPU(s) 2008 may be a coprocessor of one or more of the CPU(s) 2006. The GPU(s) 2008 may be used by the computing device 2000 to render graphics (e.g., 3D graphics) or perform general purpose computations. For example, the GPU(s) 2008 may be used for General-Purpose computing on GPUs (GPGPU). The GPU(s) 2008 may include hundreds or thousands of cores that are capable of handling hundreds or thousands of software threads simultaneously. The GPU(s) 2008 may generate pixel data for output images in response to rendering commands (e.g., rendering commands from the CPU(s) 2006 received via a host interface). The GPU(s) 2008 may include graphics memory, such as display memory, for storing pixel data or any other suitable data, such as GPGPU data. The display memory may be included as part of the memory 2004. The GPU(s) 2008 may include two or more GPUs operating in parallel (e.g., via a link). The link may directly connect the GPUs (e.g., using NVLINK) or may connect the GPUs through a switch (e.g., using NVSwitch). When combined together, each GPU 2008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 2006 and/or the GPU(s) 2008, the logic unit(s) 2020 may be configured to execute at least some of the computer-readable instructions to control one or more components of the computing device 2000 to perform one or more of the methods and/or processes described herein. In embodiments, the CPU(s) 2006, the GPU(s) 2008, and/or the logic unit(s) 2020 may discretely or jointly perform any combination of the methods, processes and/or portions thereof. One or more of the logic units 2020 may be part of and/or integrated in one or more of the CPU(s) 2006 and/or the GPU(s) 2008 and/or one or more of the logic units 2020 may be discrete components or otherwise external to the CPU(s) 2006 and/or the GPU(s) 2008. In embodiments, one or more of the logic units 2020 may be a coprocessor of one or more of the CPU(s) 2006 and/or one or more of the GPU(s) 2008.

Examples of the logic unit(s) 2020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 2010 may include one or more receivers, transmitters, and/or transceivers that enable the computing device 2000 to communicate with other computing devices via an electronic communication network, included wired and/or wireless communications. The communication interface 2010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 2020 and/or communication interface 2010 may include one or more data processing units (DPUs) to transmit data received over a network and/or through interconnect system 2002 directly to (e.g., a memory of) one or more GPU(s) 2008.

The I/O ports 2012 may enable the computing device 2000 to be logically coupled to other devices including the I/O components 2014, the presentation component(s) 2018, and/or other components, some of which may be built in to (e.g., integrated in) the computing device 2000. Illustrative I/O components 2014 include a microphone, mouse, keyboard, joystick, game pad, game controller, satellite dish, scanner, printer, wireless device, etc. The I/O components 2014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 2000. The computing device 2000 may be include depth cameras, such as stereoscopic camera systems, infrared camera systems, RGB camera systems, touchscreen technology, and combinations of these, for gesture detection and recognition. Additionally, the computing device 2000 may include accelerometers or gyroscopes (e.g., as part of an inertia measurement unit (IMU)) that enable detection of motion. In some examples, the output of the accelerometers or gyroscopes may be used by the computing device 2000 to render immersive augmented reality or virtual reality.

The power supply 2016 may include a hard-wired power supply, a battery power supply, or a combination thereof. The power supply 2016 may provide power to the computing device 2000 to enable the components of the computing device 2000 to operate.

The presentation component(s) 2018 may include a display (e.g., a monitor, a touch screen, a television screen, a heads-up-display (HUD), other display types, or a combination thereof), speakers, and/or other presentation components. The presentation component(s) 2018 may receive data from other components (e.g., the GPU(s) 2008, the CPU(s) 2006, DPUs, etc.), and output the data (e.g., as an image, video, sound, etc.).

### Example Data Center

FIG. 21 illustrates an example data center 2100 that may be used in at least one embodiments of the present disclosure. The data center 2100 may include a data center infrastructure layer 2110, a framework layer 2120, a software layer 2130, and/or an application layer 2140.

As shown in FIG. 21, the data center infrastructure layer 2110 may include a resource orchestrator 2112, grouped computing resources 2114, and node computing resources (“node C.R.s”) 2116(1)-2116(N), where “N” represents any whole, positive integer. In at least one embodiment, node C.R.s 2116(1)-2116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 2116(1)-2116(N) may correspond to a server having one or more of the above-mentioned computing resources. In addition, in some embodiments, the node C.R.s 2116(1)-21161(N) may include one or more virtual components, such as vGPUs, vCPUs, and/or the like, and/or one or more of the node C.R.s 2116(1)-2116(N) may correspond to a virtual machine (VM).

In at least one embodiment, grouped computing resources 2114 may include separate groupings of node C.R.s 2116 housed within one or more racks (not shown), or many racks housed in data centers at various geographical locations (also not shown). Separate groupings of node C.R.s 2116 within grouped computing resources 2114 may include grouped compute, network, memory or storage resources that may be configured or allocated to support one or more workloads. In at least one embodiment, several node C.R.s 2116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 2112 may configure or otherwise control one or more node C.R.s 2116(1)-2116(N) and/or grouped computing resources 2114. In at least one embodiment, resource orchestrator 2112 may include a software design infrastructure (SDI) management entity for the data center 2100. The resource orchestrator 2112 may include hardware, software, or some combination thereof.

In at least one embodiment, as shown in FIG. 21, framework layer 2120 may include a job scheduler 2133, a configuration manager 2134, a resource manager 2136, and/or a distributed file system 2138. The framework layer 2120 may include a framework to support software 2132 of software layer 2130 and/or one or more application(s) 2142 of application layer 2140. The software 2132 or application(s) 2142 may respectively include web-based service software or applications, such as those provided by Amazon Web Services, Google Cloud and Microsoft Azure. The framework layer 2120 may be, but is not limited to, a type of free and open-source software web application framework such as Apache Spark™ (hereinafter “Spark”) that may utilize distributed file system 2138 for large-scale data processing (e.g., “big data”). In at least one embodiment, job scheduler 2133 may include a Spark driver to facilitate scheduling of workloads supported by various layers of data center 2100. The configuration manager 2134 may be capable of configuring different layers such as software layer 2130 and framework layer 2120 including Spark and distributed file system 2138 for supporting large-scale data processing. The resource manager 2136 may be capable of managing clustered or grouped computing resources mapped to or allocated for support of distributed file system 2138 and job scheduler 2133. In at least one embodiment, clustered or grouped computing resources may include grouped computing resource 2114 at data center infrastructure layer 2110. The resource manager 2136 may coordinate with resource orchestrator 2112 to manage these mapped or allocated computing resources.

In at least one embodiment, software 2132 included in software layer 2130 may include software used by at least portions of node C.R.s 2116(1)-2116(N), grouped computing resources 2114, and/or distributed file system 2138 of framework layer 2120. One or more types of software may include, but are not limited to, Internet web page search software, e-mail virus scan software, database software, and streaming video content software.

In at least one embodiment, application(s) 2142 included in application layer 2140 may include one or more types of applications used by at least portions of node C.R.s 2116(1)-2116(N), grouped computing resources 2114, and/or distributed file system 2138 of framework layer 2120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 2134, resource manager 2136, and resource orchestrator 2112 may implement any number and type of self-modifying actions based on any amount and type of data acquired in any technically feasible fashion. Self-modifying actions may relieve a data center operator of data center 2100 from making possibly bad configuration decisions and possibly avoiding underutilized and/or poor performing portions of a data center.

The data center 2100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 2100. In at least one embodiment, trained or deployed machine learning models corresponding to one or more neural networks may be used to infer or predict information using resources described above with respect to the data center 2100 by using weight parameters calculated through one or more training techniques, such as but not limited to those described herein.

In at least one embodiment, the data center 2100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 2000 of FIG. 20—e.g., each device may include similar components, features, and/or functionality of the computing device(s) 2000. In addition, where backend devices (e.g., servers, NAS, etc.) are implemented, the backend devices may be included as part of a data center 2100, an example of which is described in more detail herein with respect to FIG. 21.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 2000 described herein with respect to FIG. 20. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating, for each cell of one or more cells of a grid representing a region of an environment, a cell representation indicating one or more points that correspond with the cell and that represent corresponding sensor detections generated by a plurality of ego-machines in the environment;
generating, based at least on applying the cell representation for at least one of the one or more cells to one or more neural networks comprising one or more decoders, lane data indicating one or more lanes associated with the one or more cells; and
generating, based at least on the lane data, a lane graph that represents the one or more lanes on one or more roads in the environment.

2. The method of claim 1, wherein the one or more decoders comprise a cross-section decoder that outputs one or more indications of cross-sections of the one or more lanes associated with the one or more cells.

3. The method of claim 2, wherein generating the lane graph comprises aggregating at least two cross-sections associated with a bin in the region.

4. The method of claim 2, wherein generating the lane graph comprises stitching at least two cross-sections together at least based on proximity or orientation of the at least two cross-sections relative to one another.

5. The method of claim 2 further comprising using one or more trajectories to connect at least a first portion of a lane and a second portion of the lane.

6. The method of claim 2, wherein the one or more decoders comprise a connection decoder to connect at least a first portion of a lane and a second portion of the lane.

7. The method of claim 1, wherein the one or more decoders comprise an edge decoder that outputs one or more indications of Bezier curves or polyline parameterizations associated with edges of the one or more lanes.

8. The method of claim 7, wherein generating the lane graph includes projecting the one or more indications of the Bezier curves or the polyline parameterizations to a map view of the environment.

9. The method of claim 8, wherein generating the lane graph further includes stitching the one or more indications of the Bezier curves or the polyline parameterizations together across neighboring regions in the map view of the environment.

10. The method of claim 1, wherein the one or more decoders comprise an edge decoder that autoregressively outputs one or more indications of keypoints along one or more centerlines of the one or more lanes and one or more indications of offsets to lane edges of the one or more lanes.

11. The method of claim 10, wherein generating the lane graph includes projecting the one or more indications of the keypoints and the one or more indications of the offsets to a map view of the environment.

12. The method of claim 11, wherein generating the lane graph further includes stitching the one or more indications of the keypoints and the one or more indications of the offsets across neighboring regions in the map view of the environment.

13. The method of claim 1, wherein each cell representation comprises a set of point representations including a set of attributes values for attributes associated with the one or more points that correspond with the cell.

14. The method of claim 1, wherein the method is performed by at least one of:
a control system for an autonomous or semi-autonomous machine;
a perception system for an autonomous or semi-autonomous machine;
a system for performing simulation operations;
a system for performing real-time streaming;
a system for generating or presenting one or more of augmented reality content, virtual reality content, or mixed reality content;
a system for performing digital twin operations;
a system for performing deep learning operations;
a system implemented using an edge device;
a system implemented using a robot;
a system incorporating one or more virtual machines (VMs);
a system implemented at least partially in a data center;
a system for performing light transport simulation;
a system for performing collaborative content creation for 3D assets;
a system for generating synthetic data; or
a system implemented at least partially using cloud computing resources.

15. One or more processors comprising one or more processing units to:
generating, for each cell of one or more cells of a grid representing a region of an environment, a cell representation indicating one or more points that correspond with the cell and that represent corresponding sensor detections generated by a plurality of ego-machines in the environment;
generating, based at least on applying the cell representations for the one or more cells to a transformer machine learning model comprising one or more decoders, lane data indicating one or more lanes associated with the one or more cells; and
generating, based at least on the lane data, a lane graph that represents the one or more lanes on one or more roads in the environment.

16. The one or more processors of claim 15, wherein the one or more decoders comprise a cross-section decoder that outputs one or more indications of cross-sections of the one or more lanes associated with the one or more cells.

17. The one or more processors of claim 15, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

18. A system comprising:
one or more processing units to:
generate, based at least on applying at least one cell representation indicating one or more points corresponding with a cell of a region and representing sensor detections generated by a plurality of ego-machines in an environment to one or more neural networks comprising one or more decoders, lane data indicating one or more lanes associated with one or more cells of the region; and
generate, based at least on the lane data, a lane graph that represents the one or more lanes on one or more roads in the environment.

19. The system of claim 18, wherein the one or more decoders comprise a cross-section decoder, a connection decoder, an edge decoder, or a combination thereof.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
